(19) United States
(12) Patent Application Publication
(10) Pub. No.: US 2014/0126530 A1
(43) Pub. Date: May 8, 2014

(54) WIRELESS DEVICE, A NETWORK NODE AND METHODS THEREIN

(71) Applicant: TELEFONAKTIEBOLAGET L M ERICSSON (PUBL), Stockholm (SE)

(72) Inventors: Iana Siomina, Solna (SE); Muhammad Kazmi, Bromma (SE); Bengt Lindoff, Bjarred (SE)

(73) Assignee: TELEFONAKTIEBOLAGET L M ERICSSON (PUBL), Stockholm (SE)

(21) Appl. No.: 14/124,044

(22) PCT Filed: Jun. 18, 2012
(86) PCT No.: PCT/SE2012/050675

§ 371 Date: Dec. 5, 2013

Related U.S. Application Data
(60) Provisional application No. 61/498,344, filed on Jun. 17, 2011.

(51) Int. Cl. H04L 5/00; H04W 52/14

(52) U.S. Cl. CPC H04L 5/0073; H04W 52/146
USPC 370/330

(57) ABSTRACT

A wireless device and a method therein. The method comprises obtaining first and second sets of uplink power control parameters. The first set of uplink power control parameters is associated with a first set of time and/or frequency resources and the second set of uplink power control parameters is associated with a second set of time and/or frequency resources. The method further comprises configuring transmissions of a first type of signals using the first set of uplink power control parameters when the transmissions are comprised in the first set of time and/or frequency resources, and configuring transmissions of the first type of signals using the second set of uplink power control parameters when transmissions are comprised in the second set of time and/or frequency resources.

### TECHNICAL FIELD

Embodiments herein relate to a wireless device, a network node, and to methods therein. In particular, embodiments herein relate to configuration of uplink power control.

### BACKGROUND

The interest in deploying low-power nodes, such as pico base stations, home eNodeBs, relays, remote radio heads, etc., for enhancing the macro network performance in terms of the network coverage, capacity and service experience of individual users has been constantly increasing over the last few years. At the same time, there has been realized a need for enhanced interference management techniques to address the arising interference issues caused, for example, by a significant transmit power variation among different cells and cell association techniques developed earlier for more uniform networks.

In the Third Generation Partnership Project (3GPP), heterogeneous network deployments have been defined as deployments where low-power nodes of different transmit powers are placed throughout a macro-cell layout, implying also non-uniform traffic distribution. Such deployments are, for example, effective for capacity extension in certain areas, so-called traffic hotspots, i.e., small geographical areas with a higher user density and/or higher traffic intensity where installation of pico nodes can be considered to enhance performance. Heterogeneous deployments may also be viewed as a way of densifying networks to adopt for the traffic needs and the environment. However, heterogeneous deployments bring also challenges for which the network has to be prepared to ensure efficient network operation and superior user experience. Some challenges are related to the increased interference in the attempt to increase small cells associated with low-power nodes, also known as cell range expansion; the other challenges are related to potentially high interference in uplink due to a mix of large and small cells.

### 1.1.1 Heterogeneous Deployments

According to 3GPP, heterogeneous deployments consist of deployments where low power nodes are placed throughout a macro-cell layout. The interference characteristics in a heterogeneous deployment can be significantly different than in a homogeneous deployment, in downlink (DL) or uplink (UL) or both. Examples hereof are given in FIG. 1, which figure schematically illustrates various interference scenarios in heterogeneous deployment. In case (a) illustrated in FIG. 1, a macro user with no access to the Closed Subscriber Group (CSG) cell will be interfered by the HeNB, in case (b) a macro user causes severe interference towards the HeNB and in case (c), a CSG user is interfered by another CSG HeNB. 3GPP heterogeneous network scenarios, however, are not limited to deployments with CSG cells.

### 1.1.2 Cell Range Expansion

Another challenging interference scenario occurs with so-called cell range expansion, when the traditional downlink cell assignment rule diverges from a Reference Signal Received Power (RSRP) based approach, e.g., towards pathloss-based or pathgain-based approach, e.g., when adopted for cells with a transmit power lower than neighbor cells. The idea of the cell range expansion in heterogeneous networks is illustrated in FIG. 2, where the cell range expansion of a pico cell is implemented by means of a delta-parameter and the UE potentially can see a larger pico cell coverage area when the delta-parameter is used in cell selection/reselection. The cell range expansion is limited by the DL performance since UL performance typically improves when the cell sizes of neighbor cells become more balanced.

### 1.1.3 DL Interference Management for Heterogeneous Deployments

To ensure reliable and high-bitrate transmissions as well as robust control channel performance, maintaining a good signal quality is a must in wireless networks. The signal quality is determined by the received signal strength and its relation to the total interference and noise received by the receiver. A good network plan, which, among the others also includes cell planning, is a prerequisite for the successful network operation, but it is static. For more efficient radio resource utilization, it has to be complemented at least by semi-static and dynamic radio resource management mechanisms, which are also intended to facilitate interference management, and deploying more advanced antenna technologies and algorithms.

One way to handle interference is, for example, to adopt more advanced transceiver technologies, e.g., by implementing interference cancellation mechanisms in terminals. Another way, which can be complementary to the former, is to design efficient interference coordination algorithms and transmission schemes in the network.

Inter-cell interference coordination (ICIC) methods for coordinating data transmissions between cells have been specified in LTE release 8, where the exchange of ICIC information between cells in LTE is carried out via the X2 interface by means of the X2-AP protocol. Based on this information, the network can dynamically coordinate data transmissions in different cells in the time-frequency domain and also by means of power control so that the negative impact of inter-cell interference is minimized. With such coordination, base stations can optimize their resource allocation by cells either autonomously or via another network node ensuring centralized or semi-centralized resource coordination in the network. With the current 3GPP specification, such coordination is typically transparent to UEs.

Two examples of coordinating interference on data channels are illustrated in FIG. 3, wherein in example (1) data transmissions in two cells belonging to different layers, i.e., macro and pico layers, are separated in frequency, whilst in example (2) the low-interference conditions are created at some time instances for data transmissions in pico cells by suppressing macro-cell transmissions in these time instances in order e.g. to enhance performance of UEs which would otherwise experience strong interference from macro cells e.g. being closely located to macro cells. Such coordination mechanisms are possible by means of coordinated scheduling, which allows for rather dynamic interference coordination, e.g., no need to statically reserve a part of the bandwidth for highly interfering transmissions.

Unlike for the data, ICIC possibilities for control channels and reference signals are more limited, e.g. the mechanisms illustrated in FIG. 3 are not beneficial for control channels. Three known approaches of enhanced ICIC to handle the interference on DL control channels are illustrated in FIG. 4. Example (1) of FIG. 4, uses low-interference subframes in time with reduced transmit power on certain channels (the concept can also be adopted for traffic channels), example (2) uses time shift, and example (3) uses inband control channel in combination with frequency reuse. The examples (1) and (3) require standardization changes whilst example (2) is possible with the current standard but has some limitations for, e.g., TDD and is not possible with synchronous network deployments, and is not efficient at high traffic loads.

The basic idea behind interference coordination techniques as illustrated in FIG. 3 and FIG. 4 is that the interference from a strong interferer (e.g., a macro cell) is suppressed during other-cell (e.g., pico cell) transmissions, assuming that the other cells (pico) are aware about the time-frequency resources with low-interference conditions and thus can prioritize scheduling in those subframes the transmissions for users which potentially may strongly suffer from the interference caused by the strong interferers. The possibility of configuring low-interference subframes (also known as Almost Blank Subframes, or ABS) in radio nodes and exchanging this information among nodes as well as restricting UE measurements to a certain subset of subframes signaled to the UE has been recently introduced in the 3GPP standard [3GPP TS 36.331 v10.1.0 and TS 36.423 v10.1.0].

With the approaches illustrated in FIG. 3 and FIG. 4, there still can be a significant residual interference on certain time-frequency resources, e.g., from signals whose transmissions cannot be suppressed, e.g., from CRS or synchronization signals. The techniques known from the prior-art for handling that are:
signal cancellation, by which the channel is measured and used to restore the signal from (a limited number of) the strongest interferers (impact on the receiver implementation and its complexity; in practice channel estimation puts a limit on how much of the signal energy that can be subtracted),
symbol-level time shifting (no impact on the standard, but not relevant, e.g., for TDD networks and networks providing the MBMS service), which is only a partial solution to the problem since this allows to distribute interference and avoid it on certain time-frequency resources, but not to get rid of it, and
complete signal muting in a subframe, e.g., not transmitting CRS and possibly also other signals in some subframes (which is non-backward compatible to Rel. 8/9 UEs which expect CRS to be transmitted at least on antenna port 0 in every subframe, even though it is not mandated that the UE performs measurements on those signals every subframe).

To avoid interference from some signals, MBSFN subframes with no broadcast data can be configured since CRS or other signals in the data region would typically not be transmitted in such MBSFN subframes.

1.1.3.1 DL Restricted Measurement Pattern Configuration for Enhanced Inter-Cell Interference Coordination (eICIC)

To enable restricted measurements for RRM, RLM, CSI as well as for demodulation, the UE can be signaled, via RRC UE-specific signaling, the following set of patterns [see 3GPP TS 36.331 v10.1.0]:
Pattern 1: A single RRM/RLM measurement resource restriction for the serving cell.
Pattern 2: One RRM measurement resource restriction for neighbour cells (up to 32 cells) per frequency (currently only for the serving frequency).
Pattern 3: Resource restriction for CSI measurement of the serving cell with 2 subframe subsets configured per UE.

A pattern is a bit string indicating restricted and unrestricted subframes characterized by a length and periodicity, which are different for FDD and TDD (40 subframes for FDD and 20, 60 or 70 subframes for TDD).

Restricted measurement subframes are configured to allow the UE to perform measurements in subframes with improved interference conditions, which can be implemented by configuring ABS patterns at eNodeBs. If an MBSFN subframe coincides with an ABS, the subframe is considered as ABS [TS 36.423 v10.1.0]. ABS patterns can be exchanged between eNodeBs, e.g., via X2, but these patterns are not signaled to the UE.

### 1.1.4 UL Power Control in LTE

UL power control controls the transmit power of the different UL physical channels and signals. In E-UTRAN the UL power control has both an open loop component and closed loop components [3]. The former is derived by the UE in every subframe based on the network-signaled parameters and estimated path loss or path gain. The latter is governed primarily by transmit power control (TPC) commands sent in each subframe (i.e., active subframe where transmission takes place) to the UE by the network. This means a UE transmits its power based on both open loop estimation and TPC commands. Such power control approach applies for PUSCH, PUCCH and SRS. The uplink transmitted power for RACH transmission is only based on the open loop component, i.e., path loss and network-signaled parameters.

In general, the UL power control in E-UTRAN can be described as:

P_{X,c}(i)=min{P_{CMAX,c}(i),F(γ₁,γ₂,γ₃, . . . )},

where P_{X,c}(i) is the UE UL transmit power on channel/signal X in serving cell C in subframe i, P_{CMAX,c}(i) is the configured UE transmit power defined in [4] in subframe i for serving cell c, and F(γ₁, γ₂, γ₃, . . . ) is a function of multiple parameters which are specific for the channel/signal X, e.g., PUSCH, PUCCH, SRS, PRACH. The UL power control schemes for specific channels/signals are described in more detail below.

### 1.1.4.1 Power Control for UL Shared Channel

Some of the UL power control parameters for PUSCH depend also on index j, where:
j=0 indicates PUSCH (re)transmissions corresponding to a semi-persistent grant,
j=1 indicates PUSCH (re)transmissions corresponding to a dynamically scheduled grant,
j=2 indicates PUSCH (re)transmissions corresponding to the random access response grant.

The set of UL power control parameters for PUSCH comprises the parameters listed below:
M_{PUSCH,c}(i), the bandwidth of the PUSCH resource assignment expressed in number of resource blocks valid for subframe i and serving cell c;
P_{O}_{_{—}}_{PUSCH, c}(j) the parameter composed of the sum of a component P_{O}_{_{—}}_{NOMINAL,}_{_{—}}_{PUSCH, c}(j) provided from higher layers for j=0 and 1 and a component P_{O}_{_{—}}_{UE}_{_{—}}_{PUSCH, c}(j) provided by higher layers for j=0 and 1 for serving cell c. P_{O}_{_{—}}_{UE}_{_{—}}_{PUSCH,c}(2)=0 and
   P_{O}_{_{—}}_{NOMINAL}_{_{—}}_{PUSCH, c}(2)=P_{O}_{_{—}}_{PRE}+Δ_{PREAMBLE}_{_{—}}_{Msg3}, where the parameter preambleInitialReceivedTargetPower[5] (P_{O}_{_{—}}_{PRE}) and Δ_{PREAMBLE}_{_{—}}_{Msg 3} are signaled from higher layers;
α_{c}(j), the parameter in [0,1.0] for fractional path loss compensation provided by higher layers for j=0,1; the parameter is set to 1.0 for j=2;
PL_{c}=referenceSignalPower−higher layer filtered RSRP, the DL path loss estimate calculated in the UE for serving cell _{c} in dB, where
   referenceSignalPower is provided by higher layers, RSRP is defined in [6] for the reference serving cell, and the higher layer filter configuration is defined in [1] for the reference serving cell;
δ_{PUSCH,c} is a correction value, also referred to as a transmit power control (TPC) command and is included in PDCCH; the current PUSCH power control adjustment state for serving cell c is given by f_{c}(i) which is defined by:

f_{c}(i)=f_{c}(i−1)+δ_{PUSCH,c}(i−K_{PUSCH}) if accumulation is enabled, or

f_{c}(i)=δ_{PUSCH,c}(i−K_{PUSCH}) if accumulation is not enabled, where

δ_{PUSCH,c}(i−K_{PUSCH}) was signaled on PDCCH on subframe i−K_{PUSCH}, and

K_{PUSCH} is as defined in [3] (K_{PUSCH}=4 for FDD).

### 1.1.4.2 Power Control for UL Control Channel

The UL power control for PUCCH is defined for primary cell c. The set of UL power control parameters for PUCCH comprises the list of the parameters below:
P_{O}_{_{—}}_{PUCCH} is a parameter composed of the sum of a parameter P_{O}_{_{—}}_{NOMINAL}_{_{—}}_{PUCCH} provided by higher layers and a parameter P_{O}_{_{—}}_{UE}_{_{—}}_{PUCCH} provided by higher layers;
PL_{c}, the DL path loss estimate calculated in the UE for cell c;
h(n_{CQI},n_{HARQ},n_{SR}) is a PUCCH format dependent value, where n_{CQI} corresponds to the number of information bits for the channel quality information, n_{SR} indicates whether subframe i is configured for SR for the UE, and n_{HARQ} is the number of HARQ bits sent in subframe i;
Δ_{F}_{_{—}}_{PUCCH}(F), PUCCH format-specific parameter provided by higher layers (can be from −1 dB to 6 dB), where each Δ_{F}_{_{—}}_{PUCCH}(F) value corresponds to a PUCCH format (F) relative to PUCCH format 1a;
Δ_{TxD}(F), PUCCH format-specific compensation factor provided by higher layers (can be 0 dB or −2 dB), if the UE is configured by higher layers to transmit PUCCH on two antenna ports;
δ_{PUCCH} is a UE specific correction value, also referred to as a TPC command, included in a PDCCH; the current PUSCH power control adjustment state for serving cell _{c} is given by f_{c}(i) which is defined

$$g ( i ) = g ( i - 1 ) + {\sum }_{m = 0}^{M - 1} {δ}_{PUCCH} ( i - {k}_{m} ) ,$$

where g(i) is the current PUCCH power control adjustment state in subframe i, and M,kₘ are as defined in [3].

### 1.1.4.3 Power Control for SRS

The set of parameters for SRS power setting for serving cell c in subframe i is as follows:
P_{SRS}_{_{—}}_{OFFSET,c}(m), a 4-bit parameter semi-statically configured by higher layers for m=0 and m=1 for serving cell c. For SRS transmission given trigger type 0 then m=0 and for SRS transmission given trigger type 1 then m=1. For K_{S}=1.25, P_{SRS}_{_{—}}_{OFFSET,c}(m has 1 dB step size in the range [−3, 12] dB. For K_{S}=0, P_{SRS}_{_{—}}_{OFFSET,c}(m) has 1.5 dB step size in the range [−10.5, 12] dB;
M_{SRS,c}, the bandwidth of the SRS transmission in subframe i for serving cell C;
P_{O}_{_{—}}_{PUSCH, c}(j) and α_{c}(j) are parameters as defined for power control for PUSCH when j=1;
PL_{c}, the DL path loss estimate calculated in the UE for cell c;
f_{c}(i) is the current PUSCH power control adjustment state for serving cell c.

### 1.1.4.4 Power Control for Random Access Transmission

From the physical layer perspective, the layer-1 (L1) random access procedure comprises of the transmission of random access preamble and random access response. The remaining messages are scheduled for transmission by the higher layer on the shared data channel and are not considered part of the L1 random access procedure (see Sec. 1.1.4.1 for details on power control for PUSCH).

The transmit power of the UE for performing random access is controlled by a set of signalled parameters and pre-defined rules. The uplink random access power control is applied to both contention based and non-contention based random access transmissions.

The following steps are required for the L1 random access procedure:

1. Layer 1 procedure is triggered upon request of a preamble transmission by higher layers.
2. A preamble index, a target preamble received power (PREAMBLE_RECEIVED_TARGET_POWER), a corresponding RA-RNTI and a PRACH resource are indicated by higher layers as part of the request.
3. A preamble transmission power P_{PRACH} is determined [3GPP TS 36.213] as: P_{PRACH}=Min{P_{CMAX,c}(i) PREAMBLE_RECEIVED_TARGET_POWER+PL_{c}}_[dBm] where P_{CMAX,c}(i) is the configured UE transmit power defined in [6] for subframe i of the primary cell; PL_{c} is the downlink pathloss estimate calculated in the UE for the primary cell; and PREAMBLE_RECEIVED_TARGET_POWER is updated at the MAC layer with (PREAMBLE_TRANSMISSION_COUNTER−1)*powerRampingStep, i.e., depending on the number of RA attempts, and the MAC layer then instructs the physical layer to transmit a preamble using the selected PRACH, corresponding RA-RNTI, preamble index and PREAMBLE_RECEIVED_TARGET_POWER.
4. A preamble sequence is selected from the preamble sequence set using the preamble index.
5. A single preamble is transmitted using the selected preamble sequence with transmission power P_{PRACH} on the indicated PRACH resource.
6. Detection of a PDCCH with the indicated RA-RNTI is attempted during a window controlled by higher layers. If detected, the corresponding DL-SCH transport block, which contains the uplink grant, is passed to the UE higher layers.

Furthermore the embodiments of the present invention are applicable in wide range of scenarios (not limited to) involving RACH e.g. initial access, RRC connection re-establishment (e.g. after radio link failure, handover failure etc), handover, positioning measurements, cell change, re-direction upon RRC connection release, attaining uplink synchronization (e.g. in long DRX, after long inactivity, data arrival during long inactivity etc) etc.

### 1.1.5 UL Interference Management in Heterogeneous Deployments

In general in LTE, the UL interference is coordinated by means of scheduling and UL power control, where the UE transmit power is configured to meet a certain SNR target which can be further fine-tuned by a few other related parameters.

The background on general UL power control in LTE is given in Section 1.1.4. Specifically related to heterogeneous network deployments, it has been recognized that cell range expansion creating challenging interference situation for receiving downlink signals, actually improve the UL interference making it more uniform since with cell range expansion the small cells are becoming larger and thus closer in size to macro cell. This means that the difference in the transmit power of power controlled UEs at the cell edge of macro and pico cells reduces with cell range expansion.

Without cell range expansion, the difference in UL transmit power can vary a lot for the cell edge UE, depending on the cell size which in turn is determined by the DL transmit power. To compensate for this UL power difference, there has been proposed a biased UL power control approach which compensates for the transmit power difference at different base stations [1]. According to this approach, the P₀ parameter can be increased in the low-power nodes, e.g.,

P_{O}_{_{—}}_{PUSCH}_{_{—}}ₗₚₙ(j)=P_{O}_{_{—}}_{PUSCH}_{_{—}}_{macro}(j)+(P_{macro}−Pₗₚₙ),

where P_{O}_{_{—}}_{PUSCH}_{_{—}}ₗₚₙ(j) corresponds to P_{O}_{_{—}}_{PUSCH}(j) in a low-power node, and P_{O}_{_{—}}_{PUSCH}_{_{—}}_{macro}(j) corresponds to P_{O}_{_{—}}_{PUSCH}(j) in a macro base station. A similar UL power control strategy could also be used, for example, for UL control channels.

Another challenging UL interference scenario can occur in CSG cells when a macro UE of a large macro cell strongly interfere to the small CSG cell to which it is not able to reselect since it is not a subscriber to this CSG. Using ABS in such situations to separate in time UL transmissions of macro and CSG UEs can be envisioned.

### 1.1.6 Carrier Aggregation

Embodiments of the invention described herein apply for non-CA and CA networks. The CA concept is briefly explained below.

A multi-carrier system (or interchangeably called as the carrier aggregation (CA)) allows the UE to simultaneously receive and/or transmit data over more than one carrier frequency. Each carrier frequency is often referred to as a component carrier (CC) or simply a serving cell in the serving sector, more specifically a primary serving cell or secondary serving cell. The multi-carrier concept is used in LTE release 10 and onwards. Carrier aggregation is supported for both contiguous and non-contiguous component carriers (see FIG. 4A). In non-contiguous CA, the CCs may or may not belong to the same frequency bands. The component carriers originating from the same eNodeB need not provide the same coverage. Multiple serving cells are possible with CA, where a serving cell may be a primary cell or secondary cell.

Serving Cell: For a UE in RRC_CONNECTED state not configured with CA there is only one serving cell comprising of the primary cell. For a UE in RRC_CONNECTED configured with CA the term ‘serving cells’ is used to denote the set of one or more cells comprising of the primary cell and all secondary cells.

Primary Cell (Pcell): the cell, operating on the primary frequency, in which the UE either performs the initial connection establishment procedure or initiates the connection re-establishment procedure, or the cell indicated as the primary cell in the handover procedure.

Secondary Cell (Scell): a cell, operating on a secondary frequency, which can be configured once an RRC connection is established and which can be used to provide additional radio resources.

In the downlink, the carrier corresponding to the PCell is the Downlink Primary Component Carrier (DL PCC) while in the uplink it is the Uplink Primary Component Carrier (UL PCC). Depending on UE capabilities, Secondary Cells (SCells) can be configured to form together with the PCell a set of serving cells. In the downlink, the carrier corresponding to SCell is a Downlink Secondary Component Carrier (DL SCC) while in the uplink it is an Uplink Secondary Component Carrier (UL SCC).

The carrier aggregation can also be inter-RAT CA. In this case the CCs can belong to different RATs. The inter-RAT CA can be used in the downlink and/or in the uplink. A well-known example which is known in prior art is combination of LTE and HSPA carriers. In this case the PCell and SCell can belong to carriers of any of the RATs.

1.2 Problems with Existing Solutions

At least the following problems can occur with the prior-art solutions.

The prior art scheduling and power control allow for coordinating transmit occasions and UL power transmissions, respectively. However, the prior art solutions are suffering from restricted network flexibility which may lead to excessive signalling overhead. Further, the prior art solutions are constrained by the UE behaviour currently standardized in [3]. Further, for enhanced interference coordination, there is in the prior art no concept of simultaneously configuring multiple UL ABS-like patterns or any low-transmission activity pattern over designated time-frequency resources on the same carrier frequency, in addition to regular subframes, where the pattern can be associated with a power level and/or one or a group of channel/signal types.

### SUMMARY

Among other things, methods and apparatuses in accordance with embodiments described herein comprise one or more of the following aspects:

multi-level UL power control,

signaling means enabling configuring of multiple UL transmit power levels for the same UE in specific time-frequency resources and for exchanging the related information among network elements (e.g., a UE and a radio node, two radio nodes, a radio node and a network node, a UE and a network node, etc.),

methods of configuring multiple UL transmit power levels in network nodes,

low-interference positioning subframes or time-frequency resources in UL and there are no patterns that specify such resources,

UE behavior, criteria, and signaling means for enabling the UE to select the multi-level power control operation and associated parameters for performing the multi-level power control operation.

An object of embodiments herein is to provide a way of improving the performance in a communications network.

According to a first aspect of embodiments herein, the object is achieved by a method in a wireless device for configuration of uplink power control.

The wireless device obtains a first set of uplink power control parameters and a second set of uplink power control parameters for transmitting a first type of signals.

The first set of uplink power control parameters is associated with a first set of time and/or frequency resources and the second set of uplink power control parameters is associated with a second set of time and/or frequency resources.

Further, the wireless device configures transmissions of the first type of signals using the first set of uplink power control parameters when the transmissions are comprised in the first set of time and/or frequency resources.

Furthermore, the wireless device configures transmissions of the first type of signals using the second set of uplink power control parameters when transmissions are comprised in the second set of time and/or frequency resources.

According to a second aspect of embodiments herein, the object is achieved by a wireless device for configuration of uplink power control.

The wireless device comprises an obtaining circuit configured to obtain a first set of uplink power control parameters and a second set of uplink power control parameters for transmitting a first type of signals.

The first set of uplink power control parameters is associated with a first set of time and/or frequency resources, and the second set of uplink power control parameters is associated with a second set of time and/or frequency resources.

The wireless device comprises further a configuring circuit configured to configure transmissions of the first type of signals using the first set of uplink power control parameters when the transmissions are comprised in the first set of time and/or frequency resources.

Further, the configuring circuit is configured to configure transmissions of the first type of signals using the second set of uplink power control parameters when transmissions are comprised in the second set of time and/or frequency resources.

According to a third aspect of embodiments herein, the object is achieved by a method in a network node for configuration of uplink power control of a wireless device.

The network node configures a first set of uplink power control parameters for transmitting a first type of signals.

The first set of uplink power control parameters is associated with a first set of time and/or frequency resources. Further, the first set of uplink power control parameters control the wireless device's transmissions of the first type of signals when the transmissions are comprised in the first set of time and/or frequency resources.

Further, the network node configures a second set of uplink power control parameters for transmitting the first type of signals.

The second set of uplink power control parameters is associated with a second set of time and/or frequency resources. Further, the second set of uplink power control parameters control the wireless device's transmissions of the first type of signals when the transmissions are comprised in the second set of time and/or frequency resources.

According to a fourth aspect of embodiments herein, the object is achieved by a network node for configuration of uplink power control of a wireless device.

The network node comprises a configuring circuit configured to configure a first set of uplink power control parameters for transmitting a first type of signals.

The first set of uplink power control parameters is associated with a first set of time and/or frequency resources. Further, the first set of uplink power control parameters control the wireless device's transmissions of the first type of signals when the transmissions are comprised in the first set of time and/or frequency resources.

Further, the configuring circuit is configured to configure a second set of uplink power control parameters for transmitting the first type of signals.

The second set of uplink power control parameters is associated with a second set of time and/or frequency resources. Further, the second set of uplink power control parameters control the wireless device's transmissions of the first type of signals when the transmissions are comprised in the second set of time and/or frequency resources.

Since transmissions of the first type of signals are configured using the first set of uplink power control parameters when the transmissions are comprised in the first set of time and/or frequency resources, and since transmissions of the first type of signals is configured using the second set of uplink power control parameters when transmissions are comprised in the second set of time and/or frequency resources, an improved UL interference coordination is achieved. This results in an improved performance in the communications network.

An advantage of embodiments herein is that a flexible UL interference coordination in time-frequency domain is provided.

A further advantage of embodiments herein is that multiple UL transmit power configurations for the same UE on the same channel/signal are provided.

A yet further advantage of embodiments herein is that UL transmit power patterns for higher-power transmissions and/or lower-power transmissions associated with the second UL power control are provided.

A further advantage of embodiments herein is that UE behaviour is optimized to operate with multiple-level UL power control.

A yet further advantage of embodiments herein is that an enhanced UL power control in advanced deployments is provided.

### BRIEF DESCRIPTION OF THE DRAWINGS

Examples of embodiments herein are described in more detail with reference to attached drawings in which:

FIG. 1 schematically illustrates some example scenarios in heterogeneous deployments;

FIG. 2 schematically illustrates cell range expansion in heterogeneous networks;

FIG. 3 schematically illustrates Inter-Cell Interference Coordination (ICIC) for data channels, which data channels in example (1) is in frequency, and in example (2) uses low-interference subframes in time;

FIG. 4 schematically illustrates ICIC for control channels, which control channels in example (1) uses low-interference subframes in time with reduced transmit power on certain channels, in example (2) uses time shifts, and in example (3) uses inband control channel in combination with frequency use;

FIG. 4A schematically illustrates a LTE carrier aggregation or multi-carrier system;

FIG. 5 is a schematic block diagram illustrating embodiments of a communications system;

FIG. 6 is a flowchart depicting embodiments of a method in a wireless device;

FIG. 7 is a schematic block diagram illustrating embodiments of a wireless device;

FIG. 8 is a flowchart depicting embodiments of a method in a network node;

FIG. 9 is a schematic block diagram illustrating embodiments of a network node;

FIG. 10 is a schematically example comprising multiple UL transmit power patterns indicating specific time resources over full bandwidth;

FIG. 11A schematically illustrates a positioning architecture in LTE;

FIG. 11B schematically illustrates a positioning architecture in LTE

FIG. 12 schematically illustrates the basic LTE DL physical resource as a time-frequency grid of resource elements;

FIG. 13 schematically illustrates the organization over time of an LTE DL OFDM carrier in FDD mode;

FIG. 14 schematically illustrates the LTE DL physical resource in terms of physical resource blocks;

FIG. 15A is a schematic block diagram illustrating embodiments of a portion of a transmitter;

FIG. 15B is a schematic block diagram illustrating embodiments of a symbol generator; and

FIG. 16 is a schematic block diagram illustrating embodiments of an arrangement in a UE.

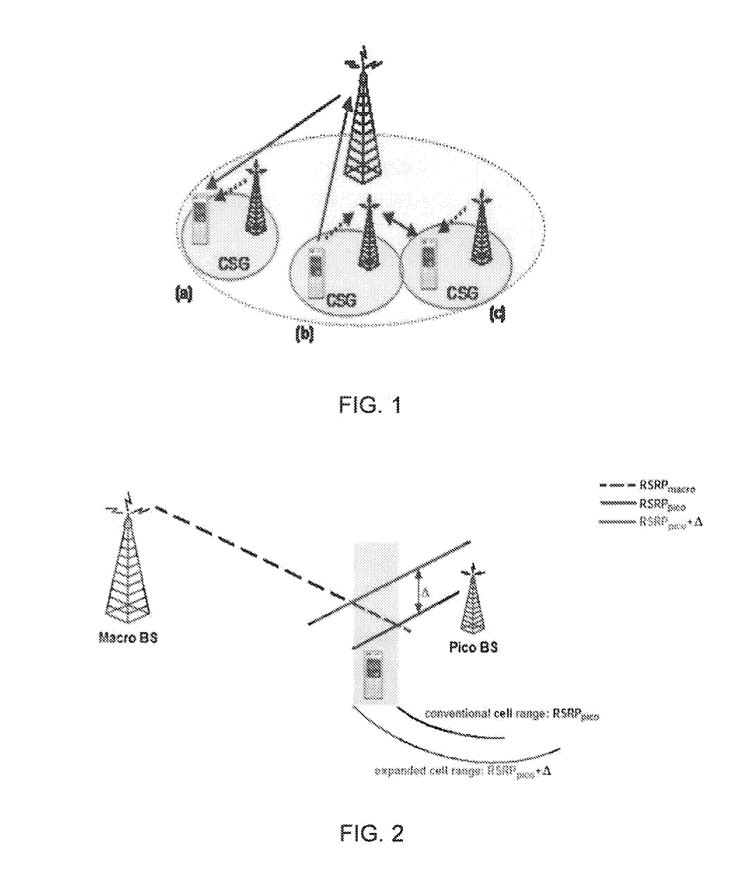

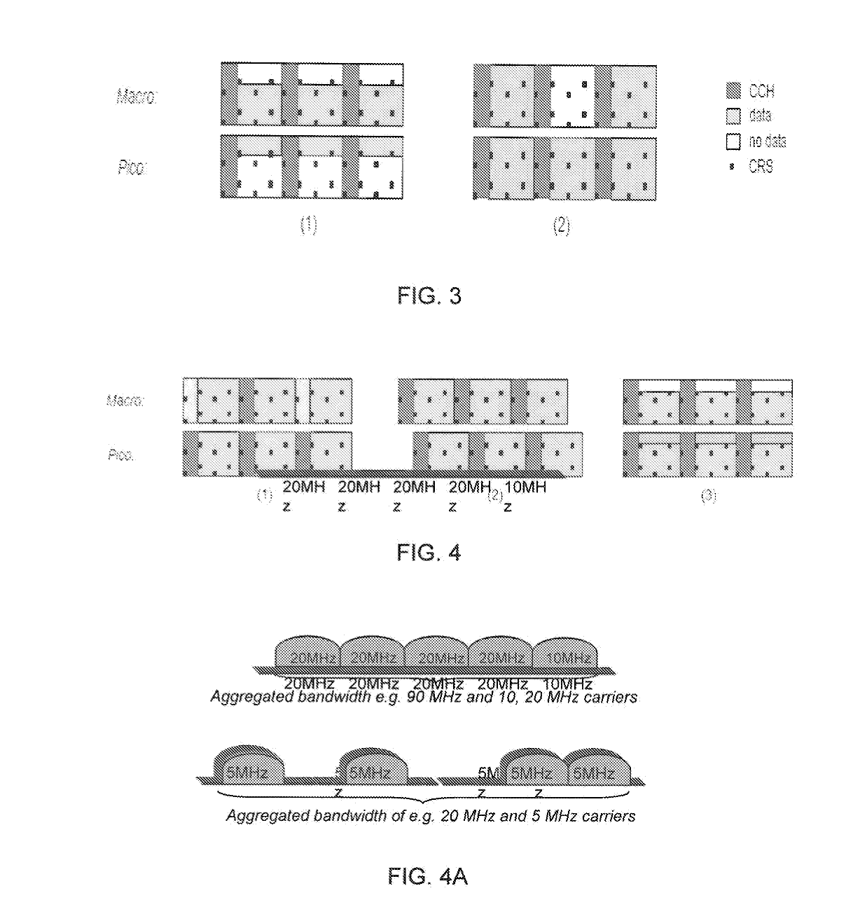

### DETAILED DESCRIPTION

Methods and apparatuses in accordance with embodiments will be described herein with a primary focus on heterogeneous deployments, which shall not be viewed as a limitation of embodiments, which also shall not be limited to the 3GPP definition of heterogeneous network deployments. For example, the methods may be adopted also for traditional macro deployments and/or networks operating more than one radio access technology (RAT).

The signaling described in accordance with embodiments herein is either via direct links or logical links, e.g., via higher-layer protocols and/or via one or more network nodes. For example, signaling from a coordinating node may pass another network node, e.g., a radio node.

Although this description is given for a user equipment (UE), as a measuring unit, it should be understood by the skilled in the art that “UE” is a non-limiting term which means any wireless device, terminal or network node capable of receiving (DL) and transmitting (UL) (e.g., PDA, laptop, (e.g., PDA, laptop, mobile, sensor, fixed relay, mobile relay, and even a radio base station that has a measurement capability). Embodiments herein may apply also for a CA-capable UE, in its general sense, as described above.

A cell is associated with a radio node, where the expressions radio node or radio network node or eNodeB are used interchangeably in this description, comprises in a general sense any node transmitting radio signals used for measurements, e.g., eNodeB, macro/micro/pico base station, home eNodeB, relay, beacon device, or repeater. A radio node herein may comprise a radio node operating in one or more frequencies or frequency bands. It may be a radio node capable of CA. It may also be a single- or multi-RAT node which may e.g. support multi-standard radio (MSR) or may operate in a mixed mode.

The term “coordinating node” used herein is a network node which may also be a radio network node which coordinates radio resources with one or more radio network nodes. A coordinating node may also be a gateway node.

The embodiments are not limited to LTE, but may apply with any RAN, single- or multi-RAT. Some other RAT examples are LTE-Advanced, UMTS, GSM, cdma2000, WiMAX, and WiFi (IEEE 802.11).

As previously mentioned, at least the following problems may occur with the prior-art solutions.

The prior art scheduling and power control allow for coordinating transmit occasions and UL power transmissions, respectively; however, it is not possible to configure different sets of UL power control parameters and UL power control loops running simultaneously for the same channel/signal type for the same UE without restarting the current power control adjustment states, which restricts network flexibility, can lead to excessive signalling overhead in attempt to approach such possibility, and is constrained by the UE behaviour currently standardized in [3].

Further, there is no concept of using UL transmit power patterns comprising at least two different power levels for the same signal/channel for the same UE on the same carrier at different times, where the times can follow a certain pattern.

For enhanced interference coordination, there is no concept of simultaneously configuring multiple UL ABS-like patterns or any low-transmission activity pattern over designated time-frequency resources on the same carrier frequency, in addition to regular subframes, where the pattern can be associated with a power level and/or one or a group of channel/signal types.

There are no prior-art methods allowing the UE to use different power levels in normal subframes and the subframes with improved interference conditions, e.g., ABS-like subframes configured for UL, on the same carrier frequency.

There are no signalling means to configure the UE for the different power levels in different types of subframes on the same carrier frequency.

There are no methods in coordinating network nodes (e.g., SON, etc.), radio network nodes and UE for determining the different power levels for the same UE on the same carrier.

There are no methods of configuring and/or pre-defined rules for determining when and which of the multiple power levels apply.

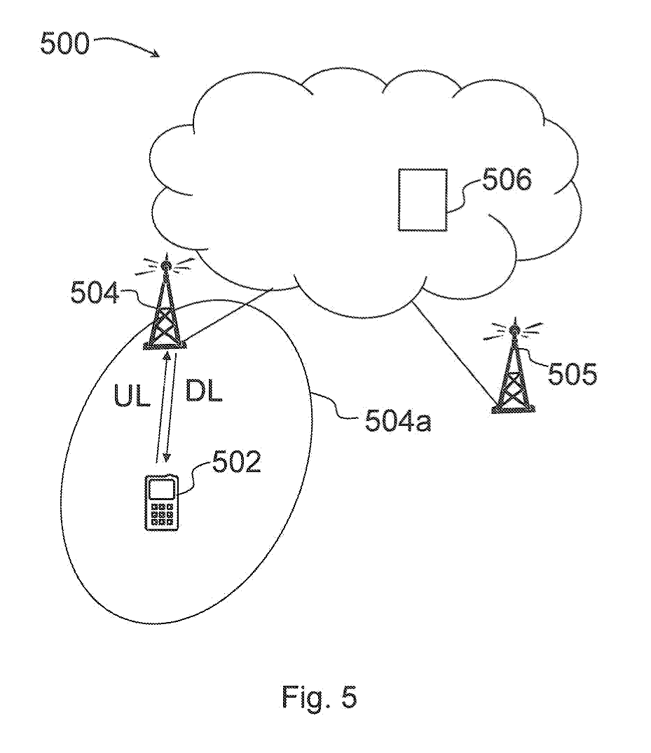

FIG. 5 schematically illustrates embodiments of a radio communications system 500. The radio communication system 500 may be a 3GPP communications system or a non-3GPP communications system.

The radio communication system 500 comprises a user equipment, herein also referred to as a wireless device 502. The wireless device 502 may be e.g. a mobile terminal or a wireless terminal, a mobile phone, a computer such as e.g. a laptop, a tablet pc such as e.g. a Personal Digital Assistant (PDA), or any other radio network unit capable to communicate over a radio link in a cellular communications network. The wireless device 502 may further be configured for use in both a 3GPP network and in a non-3GPP network.

The radio communication system 500 may comprise one or more different network nodes 504,506, such as a radio network node 504. The radio network node 504 is capable of serving the wireless device 502.

The radio network node 504 may be a base station such as an eNB, an eNodeB, Node B or a Home Node B, a Home eNode B, a measurement unit measuring UL signals such as Location Measurement Units (LMUs), a radio network controller, a coordinating node, a base station controller, an access point, a relay node (which may be fixed or movable), a donor node serving a relay, a GSM/EDGE radio base station, a Multi-Standard Radio (MSR) base station or any other network unit capable to serve the wireless device 502 in the cellular communications system 500.

Further, the radio network node 504 provides radio coverage over at least one geographic area 504a. The at least one geographic area 504a may form a cell. The wireless device 502 transmits data over a radio interface to the radio network node 504 in an uplink (UL) transmission and the radio network node 504 may transmit data to the wireless device 502 in a downlink (DL) direction in some embodiments. A number of other wireless devices, not shown, may also be located within the geographic area 504a.

The radio communication system 500 may further comprise another network node 505 such as non-serving radio network node, e.g. a non-serving base station, or a non-primary radio network node, e.g. a non-primary bases station, or a LMU 505.

Furthermore, the radio communication system 500 may comprise yet another network node 504,506 such as a positioning node 506 or a coordinating node.

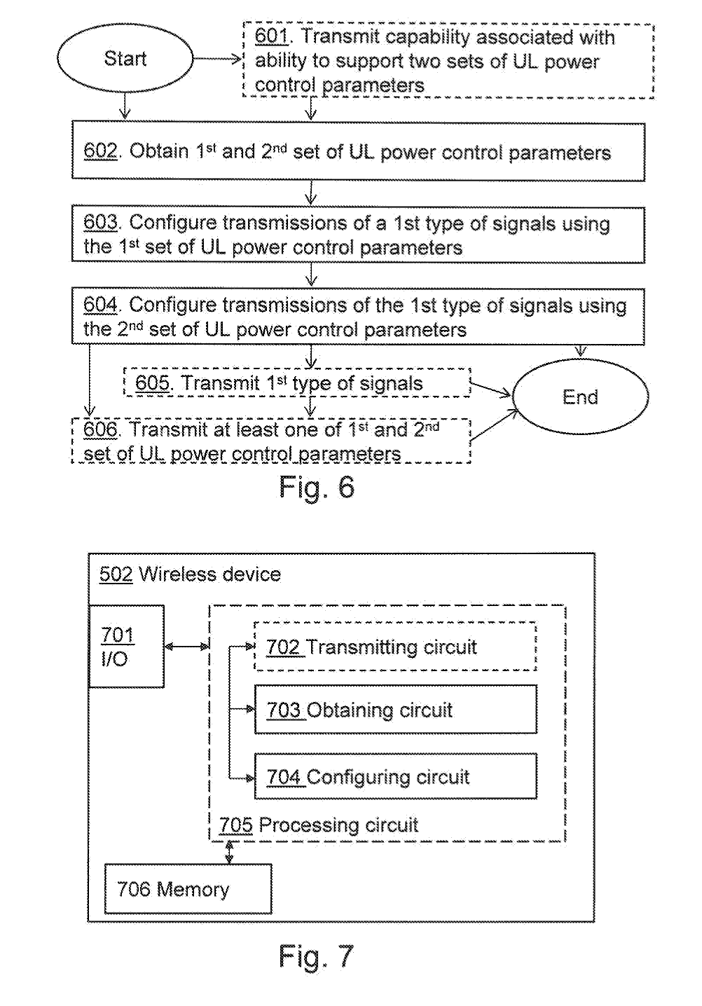

A method in a wireless device 502 for configuration of uplink power control will now be described with reference to FIG. 6.

The actions do not have to be performed in the order stated below, but may be taken in any suitable order. Further, actions may be combined. Optional actions are indicated by dashed boxes.

Action 601

In order to inform one or more network nodes 504,506 of its ability to support two sets of uplink power control parameters for uplink transmissions of a first type of signal, the wireless device 502 may transmit to a network node 504,506 a capability associated with the ability to support two sets of uplink power control parameters for uplink transmissions of the first signal.

The first signal may be a physical uplink control channel, a physical uplink data channel, an uplink physical signal which may be an uplink physical reference signal, or a physical random access channel.

Action 602

In order to be able to provide configuration of uplink power control, the wireless device 502 obtains a first set of uplink power control parameters and a second set of uplink power control parameters for transmitting the first type of signals.

The first set of uplink power control parameters is associated with a first set of time and/or frequency resources.

Further, the second set of uplink power control parameters is associated with a second set of time and/or frequency resources.

In some embodiments, the second set of uplink power control parameters comprises one or more of UE-specific uplink power control parameters, UE-group specific uplink power control parameters, or cell-specific uplink power control parameters.

The first and second sets of time and/or frequency resources may be comprised in the same subframe or the first and second sets of time and/or frequency resources may be comprised in different subframes.

Further, at least one of the first and second set of time and/or frequency resources may be comprised in a part of the system bandwidth. Thereby, even better interference coordination may be achieved, which is especially important when the bandwidth is relatively large and/or only a part of the bandwidth is used reserved for a certain type of transmissions.

In some embodiments, one of the sets of time and/or frequency resources, e.g., the first set is not restricted. Thus, the first set of time and/or frequency resources may comprise any of: restricted and non-restricted resources.

The second set of time and/or frequency resources may comprise restricted resources, which restricted resources of a cell overlap with low-interference time and/or frequency resources configured in an interfering neighbor cell. The low-interference resources may comprise resources characterized by any one of: low transmission activity, zero or reduced power transmission of all or a subset of signals in the interfering neighbour cell.

Further, the second set of time and/or frequency resources may be comprised in a pattern, e.g., a transmit pattern which may be Almost Blank Subframe, ABS, pattern.

In some embodiments, the action of obtaining at least the second set of uplink power control parameters comprises one or a combination of: receiving the second set of uplink power control parameters from a network node 504,506 associated with the wireless device 502, configuring pre-defined values for the second set of uplink power control parameters, deriving the second set of uplink power control parameters based on a pre-defined rule, or deriving the second set of uplink power control parameters based on the first set of uplink power control parameters.

The wireless device 502 may obtain at least one of the first set of uplink power control parameters and the second set of uplink power control parameters by receiving absolute values of an uplink received signal target or by receiving relative values of the uplink received signal target. The relative values may be derived from a reference value. By means of the absolute values or relative values the UL transmit power may be controlled.

An advantage with absolute values is independency on the previous set of parameters (which may or may not be properly received by the wireless device). An advantage with relative values is less signalling overhead since relative values are typically smaller than the absolute values but in a typical implementation there is a dependency on a previous or some reference set of the parameters.

In some embodiments at least some the uplink power control parameters may be pre-defined.

Action 603

The wireless device 502 configures transmissions of the first type of signals using the first set of uplink power control parameters when the transmissions are comprised in the first set of time and/or frequency resources.

Action 604

The wireless device 502 configures transmissions of the first type of signals using the second set of uplink power control parameters when transmissions are comprised in the second set of time and/or frequency resources.

In some embodiments, the wireless device 502 configures the transmissions of the first type of signals using the second set of uplink power control parameters when one or more conditions are met. Thereby, the applicability of the multilevel UL power control or its certain power levels may be restricted. Further, more flexibility and better adaptivity may be provided. Furthermore, less complexity may be provided, since the selection (e.g. of wireless device 502) may be not in the network side or may be less accurate, but then the wireless device 502 which may have more information, may use the second configuration, e.g. the second set of uplink power control parameters, when it really needs and perhaps also depending on its capabilities or resource availability.

A condition may be determined by at least one of the transmissions purpose, radio environment, interference condition, geographical location, signal type, or resource type.

Action 605

The wireless device 502 may transmit the first type of signal using at least one of the first and second set of uplink power control parameters. The wireless device 502 may transmit the first type of signal to any node comprised in the communications network 500, e.g. to the network node 504,506.

Action 606

The wireless device 502 may transmit at least one of the first and second set of uplink power control parameters to a network node 504,505,506, e.g. to a non-serving eNodeB or to a non-primary cell in CA.

To perform the method actions in the wireless device 502 described above in relation to FIG. 6 for configuration of uplink power control, the wireless device 502 comprises the following arrangement depicted in FIG. 7.

The wireless device 502 comprises an input and output port 701 configured to function as an interface for communication in the communication system 500. The communication may for example be communication with the radio network node 504 or with the network node 506. The communication may be via a direct link or via another node, e.g., communication with network node 506 may be via a radio network node 504.

A transmitting circuit 702 may be comprised in the wireless device 502. The transmitting circuit 702 is configured to transmit to the network node 504,506 a capability associated with the ability to support two sets of uplink power control parameters for uplink transmissions of a first type of signal.

The transmitting circuit 702 may further be configured to transmit the first type of signal using at least one of the first and second set of uplink power control parameters. The transmitting circuit 702 may transmit the first type of signal to any node comprised in the communications network 500, e.g. to the network node 504,506.

The first signal may be a physical uplink control channel, a physical uplink data channel, an uplink physical signal which may be an uplink physical reference signal, or a physical random access channel.

Further, the transmitting circuit 702 may be configured to transmit at least one of the first and second set of uplink power control parameters to a network node 504,505,506, e.g. to a non-serving eNodeB or to a non-primary cell in CA.

The wireless device 502 comprises further an obtaining circuit 703 configured to obtain a first set of uplink power control parameters and a second set of uplink power control parameters for transmitting the first type of signals.

The first set of uplink power control parameters is associated with a first set of time and/or frequency resources.

Further, the second set of uplink power control parameters is associated with a second set of time and/or frequency resources.

Furthermore, the uplink power control parameters may be pre-defined.

The second set of uplink power control parameters may comprise one or more of: UE-specific uplink power control parameters, UE-group specific uplink power control parameters, or cell-specific uplink power control parameters.

The first and second sets of time and/or frequency resources may be comprised in the same subframe or in different subframes.

Further, at least one of the first and second set of time and/or frequency resources may be comprised in a part of the system bandwidth.

In some embodiments, one of the sets of time and/or frequency resource, e.g. the first set, is not restricted. Thus, the first set of time and/or frequency resources may comprise any of: restricted or non-restricted resources.

The second set of time and/or frequency resources may comprise restricted resources, which restricted resources of a cell overlap with low-interference time and/or frequency resources configured in an interfering neighbor cell. The low-interference resources may comprise resources characterized by any one of low transmission activity, zero or reduced power transmission of all or a subset of signals in the interfering neighboring cell.

Further, the second set of time and/or frequency resources may be comprised in a pattern, e.g. a transmit pattern which may be an ABS pattern.

In some embodiments, the obtaining circuit 703 is further configured to receive the second set of uplink power control parameters from a network node 504,506 associated with the wireless device 502, configure pre-defined values for the second set of uplink power control parameters, derive the second set of uplink power control parameters based on a pre-defined rule, or derive the second set of uplink power control parameters based on the first set of uplink power control parameters.

Further, the obtaining circuit 703 may be configured to obtain at least one of the first set of uplink power control parameters and the second set of uplink power control parameters by receiving absolute values of an uplink received signal target or by receiving relative values of the uplink received signal target. The relative values may be derived from a reference value.

A configuring circuit 704 is further comprised in the wireless device 502. The configuring circuit 704 is configured to configure transmissions of the first type of signals using the first set of uplink power control parameters when the transmissions are comprised in the first set of time and/or frequency resources. The configuring circuit 704 is further configured to configure transmissions of the first type of signals using the second set of uplink power control parameters when transmissions are comprised in the second set of time and/or frequency resources.

In some embodiments, the configuring circuit 704 is configured to configure the transmissions of the first type of signals using the second set of uplink power control parameters when one or more conditions are met. Thereby, the applicability of the multilevel UL power control or its certain power levels may be restricted.

A condition may be determined by at least one of: the transmissions purpose, radio environment, interference condition, geographical location, signal type, resource type.

Embodiments herein for configuration of uplink power control may be implemented through one or more processors, such as a processing circuit 705 comprised in the wireless device 502 depicted in FIG. 7, together with computer program code for performing the functions and/or method actions of embodiments herein.

It should be understood that one or more of the circuits comprised in the wireless device 502 described above may be integrated with each other to form an integrated circuit.

The wireless device 502 may further comprise a memory 706. The memory 706 may comprise one or more memory units and may be used to store for example data such as thresholds, predefined or pre-set information, etc.

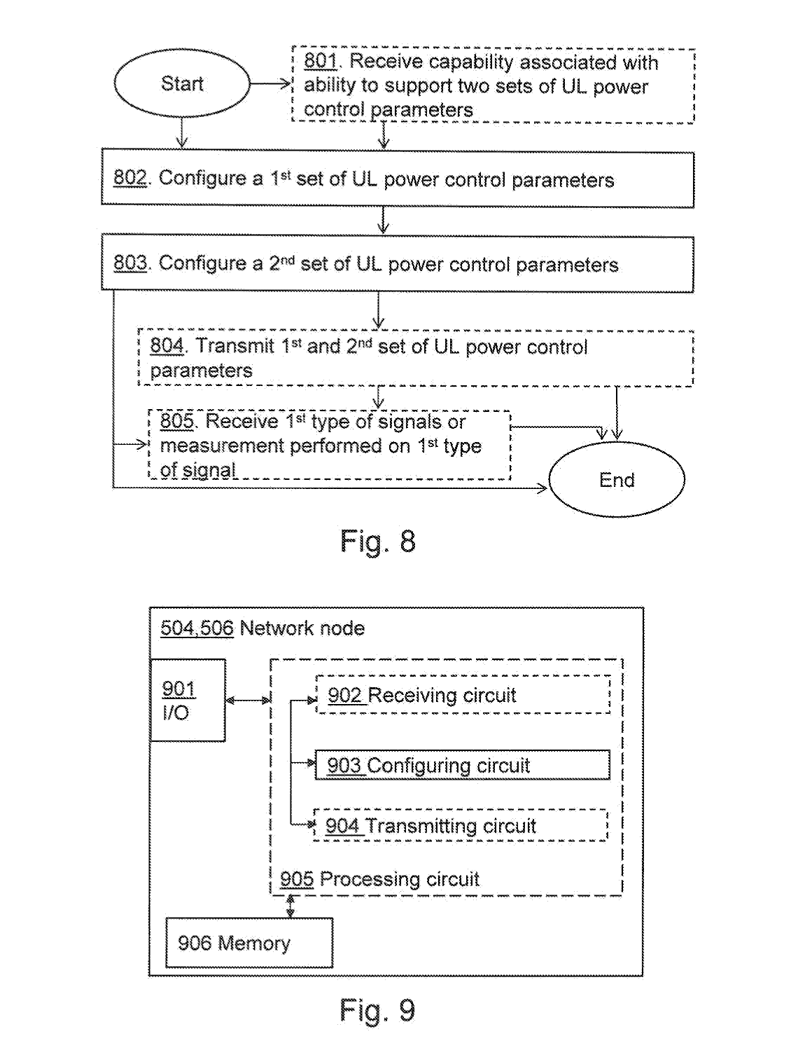

A method in a network node 504,506 for configuration of uplink power control of a wireless device 502 will now be described with reference to FIG. 8. The network node 504, 506 may be a radio network node 504 or another network node such as a positioning node 506 or a coordinating node. As previously mentioned, the wireless device 502 and the network node 504, 506 are comprised in the communications system 500.

The actions do not have to be performed in the order stated below, but may be taken in any suitable order. Further, actions may be combined. Optional actions are indicated by dashed boxes.

Action 801

In order to obtain knowledge about the wireless device's 502 ability to support two sets of uplink power control parameters for uplink transmissions of a first type of signals, the network node 504,506 may receive from the wireless device 502 a capability associated with the ability to support the two sets of uplink power control parameters for uplink transmissions of the first signal.

The first signal may be a physical uplink control channel, a physical uplink data channel, an uplink physical signal which may be an uplink physical reference signal, or a physical random access channel.

Action 802

In order to provide configuration of uplink power control of the wireless device 502, the network node 504,506 configures a first set of uplink power control parameters for transmitting a first type of signals.

In some embodiments, wherein the network node 504,506 is a positioning node 506, the positioning node 506 may be configured to request configuration of the first set of uplink power control parameters for transmitting the first type of signals

The first set of uplink power control parameters is associated with a first set of time and/or frequency resources. Further, the first set of uplink power control parameters control the wireless device's 502 transmissions of the first type of signals when the transmissions are comprised in the first set of time and/or frequency resources.

The first set of time and/or frequency resources may comprise restricted or non-restricted resources.

Action 803

Further, in order to provide configuration of uplink power control of the wireless device 502, the network node 504,506 configures a second set of uplink power control parameters for transmitting the first type of signals.

In some embodiments, wherein the network node 504,506 is a positioning node 506, the positioning node 506 may be configured to request configuration of the second set of uplink power control parameters for transmitting the first type of signals.

The second set of uplink power control parameters is associated with a second set of time and/or frequency resources. Further, the second set of uplink power control parameters control the wireless device's 502 transmissions of the first type of signals when the transmissions are comprised in the second set of time and/or frequency resources.

The second set of time and/or frequency resources may be comprised in a pattern.

Further, the second set of uplink power control parameters may comprise one or more of: UE-specific uplink power control parameters, UE-group specific uplink power control parameters, or cell-specific uplink power control parameters.

Furthermore, the second set of time and/or frequency resources may comprise restricted resources, which restricted resources of a cell overlap with low-interference time and/or frequency resources configured in an interfering neighbor cell. The low-interference resources may comprise resources characterized by any of: low transmission activity, zero or reduced power transmission of all or a subset of signals.

At least one of the uplink power control parameters may be pre-defined.

The first and second sets of time and/or frequency resources may be comprised in the same subframe or in different subframes.

Furthermore, at least one of the first and second set of time and/or frequency resources may be comprised in a part of the system bandwidth.

Action 804

The network node 504,506 may further transmit the first and/or second sets of uplink power control parameters to the wireless device 502 and/or to another network node 504, 505, 506.

The another network node 504,505,506 may be a serving eNodeB 504 transmitting parameters to a positioning node 506, a positioning node 506 transmitting parameters to a LMU 505, and/or a network node 506 such as MDT, SON, positioning node, etc transmitting parameters to the serving eNodeB 504.

Action 805

The network node 504,506 may further receive the first type of signal from the wireless device 502. This may be the case when the network node 504,506 is a radio network node such as a serving eNodeB 504, a non-serving eNodeB 505, a LMU 505.

In some embodiments, the network node 504,506 may receive measurements performed on the first type of signal from another network node 504, 505, 506. For example, the LMU 504 may perform measurements and report them to a positioning node 506, or an eNodeB 504 may perform the measurements and report them to the positioning node 506.

To perform the method actions in the network node 504, 506 described above in relation to FIG. 8 for configuration of uplink power control of a wireless device 502, the network node 504, 506 comprises the following arrangement depicted in FIG. 9. As previously mentioned, the wireless device 502 and the network node 504,506 are comprised in the communications system 500.

The network node 504,506 comprises an input and output port 901 configured to function as an interface for communication in the communication system 500. The communication may for example be communication with the wireless device 502 or with another network node.

A receiving circuit 902 may be comprised in network node 504,506. The receiving circuit 902 is configured to receive from the wireless device 502 a capability associated with the ability to support two sets of uplink power control parameters for uplink transmissions of a first type of signal.

The receiving circuit 902 may further be configured to receive the first type of signal from the wireless device 502. This may be the case when the network node 504,506 is a radio network node such as a serving eNodeB 504, a non-serving eNodeB 505, a LMU 505.

The first signal may be a physical uplink control channel, a physical uplink data channel, an uplink physical signal which may be an uplink physical reference signal, or a physical random access channel.

In some embodiments, the receiving circuit 902 may receive measurements performed on the first type of signal from another network node 504, 505, 506. For example, the LMU 504 may perform measurements and report them to a positioning node 506, or an eNodeB 504 may perform the measurements and report them to the positioning node 506.

The network node 504,506 comprises a configuring circuit 903 configured to configure a first set of uplink power control parameters for transmitting a first type of signals.

The first set of uplink power control parameters is associated with a first set of time and/or frequency resources. Further, the first set of uplink power control parameters control the wireless device's 502 transmissions of the first type of signals when the transmissions are comprised in the first set of time and/or frequency resources.

The configuring circuit 903 is further configured to configure a second set of uplink power control parameters for transmitting the first type of signals.

The second set of uplink power control parameters is associated with a second set of time and/or frequency resources. Further, the second set of uplink power control parameters control the wireless device's 502 transmissions of the first type of signals when the transmissions are comprised in the second set of time and/or frequency resources.

The second set of uplink power control parameters may comprise one or more of: UE-specific uplink power control parameters, UE-group specific uplink power control parameters, or cell-specific uplink power control parameters.

In some embodiments, the first and/or second sets of uplink power control parameters are pre-defined.

Further, the first and second sets of time and/or frequency resources may be comprised in the same subframe or in different subframes.

In some embodiments, at least one of the first and second set of time and/or frequency resources is comprised in a part of the system bandwidth.

The first set of time and/or frequency resources may comprise restricted or non-restricted resources.

Further, the second set of time and/or frequency resources may comprise restricted resources, which restricted resources of a cell overlap with low-interference time and/or frequency resources configured in an interfering neighbor cell. The low-interference resources may comprise resources characterized by any one of: low transmission activity, zero or reduced power transmission of all or a subset of signals.

A transmitting circuit 904 may be comprised in the network node 504,506. The transmitting circuit 904 is configured to transmit the first and second sets of uplink power control parameters to the wireless device 502 and/or another network node 504,505,506.

The another network node 504,505,506 may be a serving eNodeB 504 transmitting parameters to a positioning node 506, a positioning node 506 transmitting parameters to a LMU 505, and/or a network node 506 such as MDT, SON, positioning node, etc transmitting parameters to the serving eNodeB 504.

Embodiments herein for configuration of uplink power control may be implemented through one or more processors, such as a processing circuit 905 comprised in the network node 504,506 depicted in FIG. 9, together with computer program code for performing the functions and/or method actions of embodiments herein.

It should be understood that one or more of the circuits comprised in the network node 504,506 described above may be integrated with each other to form an integrated circuit.

The network node 504,506 may further comprise a memory 906. The memory 906 may comprise one or more memory units and may be used to store for example data such as thresholds, predefined or pre-set information, etc.

Some embodiments relating to the actions 601-606 and 801-805, and to the wireless device 502 and the network node 504, 506 described above will be described in more detail below.

### 3.1.1. Multi-Level UL Power Control

Some embodiments comprise configuring different UL power control loops running simultaneously for the same channel/signal type for the same UE for the same cell without restarting the current power control adjustment states.

To elaborate the basic concept of embodiments herein, consider an example comprising two different UL power control loops, wherein associated parameters for each channel/signal are configured for UL power control operation in two different sets of time-frequency resources by the same UE 502. Some embodiments comprise methods of configuring the parameters associated with:
the first power control loop controlling UE output power for transmitting a first type of channel/signals in a first set of time-frequency resources, and
the second power control loop controlling UE output power for transmitting the first type channel/signals in a second set of time-frequency resources.

In one example, the first power control may operate using legacy principles. This means that any time-frequency resource may be used for uplink transmission in a first cell and without configuring any low interference time-frequency resources in a second cell. The second cell is a neighbor cell.

The second power control would typically operate using heterogeneous principles. This means that only uplink restricted time-frequency resources are used for uplink transmission in the first cell. The restricted time-frequency resources are aligned with the corresponding low interference time-frequency resources in the uplink of the second cell. The second cell is the neighbor cell and is an aggressor to the first cell, which means the uplink transmissions in the second cell causes higher interference in the uplink of the first cell. However, the interference may be reduced by means of using reduced activity or reduced power for transmissions in the second cell, which may be applied on selected set of time and/or frequency resources, e.g., the second set of time and/or frequency resources.

Examples of low-interference resources are Almost Blank Subframes (ABS) with zero or low transmission power and/or activity, blank subframes etc configured in the aggressor cell.

Another example is when low-interference time-frequency resources are restricted in the bandwidth, e.g., 6 resource blocks out of N>6 resource blocks in certain time instances. Such resources may be defined by a static, semi-static or dynamic pattern, and the pattern may be pre-defined or configured. The pattern may also be associated with a maximum transmit power level associated with the transmissions on the time-frequency resources indicated by the pattern.

The first type of channel/signal means the same type of physical channel e.g. PUSCH or PUCCH or PRACH or physical signal e.g. SRS etc.

The basic aspect of the second power control is that the second set of UL power control parameters is associated with a subset of time and/or frequency resources. In some embodiments, the second power control requires that at least restricted time-frequency resources are configured in the uplink for the uplink transmissions in the first cell.

According to another aspect of the second power control, the second set of time and/or frequency resources may be associated with downlink signals. These downlink signals may also be transmitted over downlink resources which belong to one or more restricted time-frequency resource pattern. In one example, the restricted time-frequency resource pattern for DL transmissions in the first cell may overlap or be aligned with at least some of the low-interference time-frequency resources (e.g. ABS subframes, blank MBSFN, etc.) in an aggressor cell. Examples of signals which are associated with the UL power control transmitted in the downlink are Transmit Power Control (TPC) commands etc. Another example is UL HARQ feedback transmissions transmitted in DL in response to UL transmissions. Yet another example, DL HARQ feedback transmitted in UL. Yet another example is Random Access Response, RAR, transmitted in response to random access messages.

Some embodiments herein is also applicable to multiple power control loops, for example:
a first power control loop is associated with the UE power control of the first channel/signal type as in legacy i.e. in any time-frequency resources;
a second power control loop is associated with the UE power control of the first channel/signal type only in the first set of uplink restricted time-frequency resources in the first cell;
a third set of power control loop is associated with the UE power control of the first channel/signal type only in the second set of uplink restricted time-frequency resources in the first cell and so on.

An aspect of embodiments herein is that different sets of parameters for different power control loops for the same UE 502 for the same type of channel/signal may be configured by the network for controlling the UE power.

The embodiment applies for any UL transmission. Some specific examples of such transmissions are transmissions on PUSCH, PUCCH, PRACH, SRS and demodulation reference signals (DMRS), where DMRS are associated with transmission of PUSCH or PUCCH.

In a general case, the second or third UL transmit power may be configured as a function, such as:

P^{•}_{X,c}(i)=min{P_{CMAX,c}(i),F(γ₁,γ₂,γ₃, . . . ,γ₁,γ₂, . . . )},

where γ₁, γ₂, . . . are the new parameters related to the multi-level power control, e.g., γ₁,γ₂, . . . may be applied only for the second power control and/or only for the third power control. One example parameter, e.g., λ₁, is an UL power offset relative to the prior-art P_{X,c}(i). Another example parameter, e.g., λ₂, may be used to indicate the time-frequency resources, e.g. a pattern or its index, associated with the second power control and/or third power control, respectively.

In a more specific example for PRACH transmissions, one of the second UL power control or third UL power control may use a power offset (offset) which may either be included in PREAMBLE_RECEIVED_TARGET_POWER or in P_{PRACH,} e.g., P_{PRACH}=min{P_{CMAX,c}(i), PREAMBLE_RECEIVED_TARGET_POWER+offset+PL_{c}}, where the offset may be signaled or pre-defined or configured. In one example, the configured offset may be equal or at least related to the cell reselection offset used for the UE. Furthermore, the offset parameter may be positive (boosting) or negative (reducing).

For the same channel/signal, embodiments may also apply for a specific measurement type or measurement purpose. For example, different non-zero (in linear scale) power levels for the same UE 502 may be configured for SRS used for positioning or timing measurements and SRS used for other purposes.

In another embodiment, the same UL transmit power configuration strategy, e.g., reduced UL transmit power levels or boosted UL transmit power levels, may be configured for more than one UE 502, e.g., a group of UEs, at the same time and/or frequency resource.

In some embodiments, the time-frequency resources for the transmissions are indicated by the pattern or may be derived from the pattern, e.g., as a complementary pattern. In one example, when the power is boosted it is assumed to be boosted in relation to the power level which would normally be defined for transmissions in the other time-frequency resources, e.g. not associated with the boosted power level.

### Example 1

### UL Power Control for PUSCH

The standardized UL power control for PUSCH:

$${P}_{PUSCH , c} ( i ) = min \{ \begin{matrix}{P}_{CMAX , c} ( i ) , \\ \begin{matrix}10 {log}_{10} ( {M}_{PUSCH , c} ( i ) ) + {P}_{O\_PUSCH , c} ( j ) + \\ {α}_{c} ( j ) \cdot {PL}_{c} + {Δ}_{TF , c} ( i ) + {f}_{c} ( i )\end{matrix}\end{matrix} \} [ dBm ]$$

may be enhanced, e.g., with an offset value. The offset value may be positive or negative, and may be associated with specific time-frequency resources, possibly with a set of conditions—see, e.g., Section 3.1.6, “set of conditions”. The standardized UL power control for PUSCH may be enhanced as follows:

$${P}_{PUSCH , c} ( i ) = min \{ \begin{matrix}{P}_{CMAX , c} ( i ) , \\ \begin{matrix}10 {log}_{10} ( {M}_{PUSCH , c} ( i ) ) + {P}_{O\_PUSCH , c} ( j ) + \\ {α}_{c} ( j ) \cdot {PL}_{c} + {Δ}_{TF , c} ( i ) + {f}_{c} ( i ) + offset\end{matrix}\end{matrix} \} [ dBm ]$$

where also one or more predefined rules specifying the designated time-frequency resources may be associated with specific offset values or value ranges.

### Example 2

### UL Power Control for PUCCH

In a similar way, the standardized UL power control for PUCCHmay be enhanced, e.g., as follows:

$${P}_{PUCCH} ( i ) = min \{ \begin{matrix}{P}_{CMAX , c} ( i ) , \\ \begin{matrix}{P}_{0 \_PUCCH} + {PL}_{c} + h ( {n}_{CQI} , {n}_{HARQ} , {n}_{SR} ) + {Δ}_{F\_PUCCH} ( F ) + \\ {Δ}_{T \times D} ( {F}^{′} ) + g ( i ) + offset\end{matrix}\end{matrix} \} [ dBm ]$$

### Example 3

### UL Power Control for SRS

In a similar way, the standardized UL power control for PUCCH may be enhanced, e.g., as follows:

P_{SRS,c}(i)=min{P_{CMAX,c}(i),P_{SRS}_{_{—}}_{OFFSET,c}(m)+10 log₁₀(M_{SRS,c})+P_{O}_{_{—}}_{PUSCH,c}(j)+α_{c}(j)·PL_{c}+f_{c}(i)+offset}[dBm]

### 3.1.1.1. Applicability of Multi-Level UL Transmit Power Control for Different Channels/Signals

In general the concept of multi-level UL transmit power control may apply for controlling of the uplink transmit power of signals transmitted in the uplink. The uplink signals may be transmitted on one or more physical channel or one or more physical signals.

The physical channel may be a data channel, a control channel, a channel carrying both data and control information, i.e. multiplexed data and control information. In LTE the well-known UL physical channels are PUSCH and PUCCH carrying data and control signaling, respectively. Yet another example of physical channel is the PRACH, which is used for doing random access. The PRACH may be contention based or non-contention based. An examples of control signals is feedback information such as ACK/NACK, CSI (CQI, PMI, RI) etc. The control information is associated with the downlink channels/signals. The basic PUSCH formats carry only data transmission in the uplink. More sophisticated PUSCH formats may also carry the data and control information.

The uplink physical signals may carry specific pilot or reference signals. The signals may be transmitted as standalone or multiplexed with other signals. One example of a physical signal in LTE is the sounding reference signal (SRS). The SRS is transmitted in a symbol, e.g. last symbol of a subframe.

3.1.1.2 Time and/or Frequency Association of the Multiple UL Transmit Power Levels

A time resource may comprise certain time instance or time period (T0). The time instance (T0) may in turn comprise one or more symbols, one or more slots, one or more subframes or one or more frames in LTE. A frequency resource may comprise certain part of frequency or spectrum (F0). The frequency resource (F0) may in turn comprise one or more subcarriers, one or more resource blocks in frequency or one or more frequency carriers, parts of a band or bands in LTE. A time and frequency resource, aka a time-frequency resource, is a combination of a time and a frequency resource, e.g., one or more designated resource elements or one or more designated resource blocks in LTE. A set of time and/or frequency resources may be configured according to a pattern. For example, a pattern in time domain may comprise a set of indicators where an indicator indicates two groups of time resources. For example, ‘true’ or ‘1’ may correspond to the first group and ‘false’ or ‘0’ may correspond to the second group). An example pattern may comprise a sequence ‘01000000’ of eight elements with one distinguished subframe out of 8 which may periodically repeat.

In another embodiment, a pattern may be an UL ABS pattern configured for UL interference coordination to enable time intervals with specific interference conditions, e.g., low-interference time intervals for UL transmissions. In combination with the embodiment where different UL transmit power levels for the same channel/signal apply for different measurement types or measurement purposes, embodiments herein allow, e.g., to configure UL ABS patterns for a specific measurement type or a specific measurement purpose.

One non-limiting example of such a measurement purpose is positioning. Configuring such UL low-interference positioning subframes may improve the hearability of UL signals being detected in non-serving cells, which will improve the UL positioning quality and in particular with positioning methods relying on signal measurements at multiple distinct locations such as UTDOA. This will allow to minimize or to avoid dense deployments of measurement nodes (e.g., LMUs), which has been observed in existing deployments due to the known hearability problem in networks with large cells where the UL transmissions become power-limited. In another example, time-frequency resources associated with positioning may be also associated with boosted power transmissions at least for some UEs which may imply e.g. a positive offset.

Another non-limiting example of a measurement purpose is that with UL transmissions associated with Minimizing Drive Test (MDT), e.g., measurements configured for MDT or reporting of MDT measurements which may be implemented in a best-effort fashion.

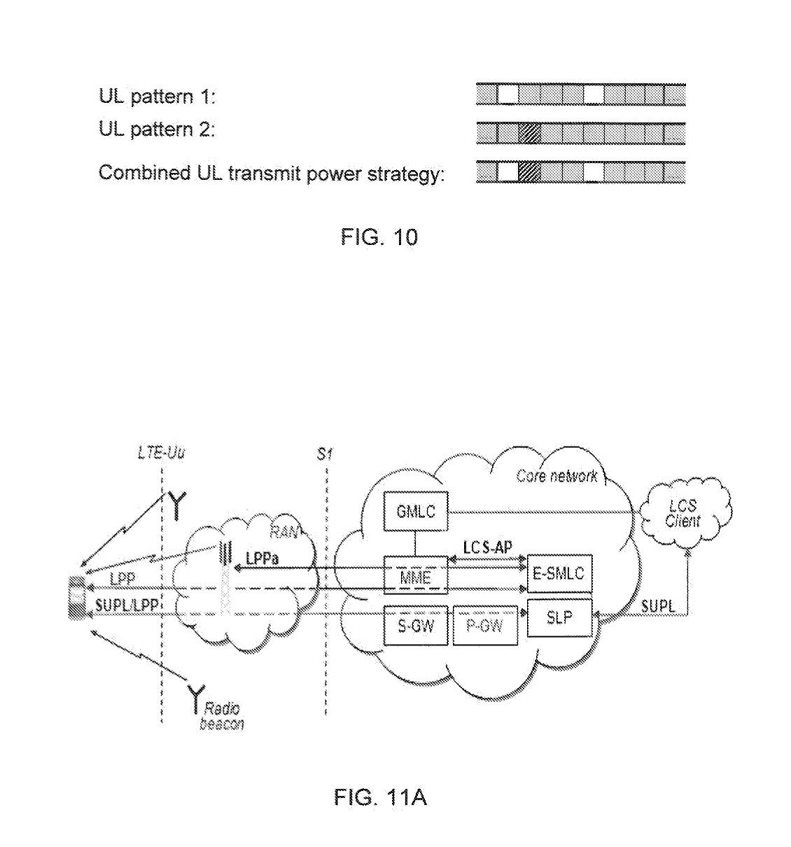

In yet another embodiment, more than one pattern maybe configured, e.g., at least for one UE there may exist time intervals for ‘normal’ UL transmissions (corresponding to UL transmit power strategy/level 0), ‘type 1’ UL transmissions (corresponding to UL transmit power strategy/level 1) and ‘type 2’ UL transmissions (corresponding to UL transmit power strategy/level 2)—see FIG. 10, which FIG. 10 schematically illustrates an example with multiple UL transmit power patterns indicating specific time resources over full bandwidth.

In another example the pattern can be associated with a part of the bandwidth which may or may not be the same in all indicated time resources.

### 3.1.1.3 Geographical Association of the Multiple UL Transmit Power Levels

In this part of the description, an UL transmit power pattern may apply in a particular geographical area, e.g., along a street or along a road to facilitate UL transmissions for higher speed UEs 502, or in a proximity of a radio node which is closer than the serving cell node to the UE 502 transmitting in UL and thus potentially experiencing higher interference from the UE 502 if the UE 502 cannot reselect to that cell (e.g., CSG cell).

### 3.1.1.4 Environmental Association of the Multiple UL Transmit Power Levels

In this part of the description, an UL transmit power pattern may apply in a particular radio environment, e.g., indoor. For example, an indoor UE 502 may be configured to transmit at a lower power at certain time intervals when being served by an outdoor radio node, e.g., macro cell, and interfering to indoor radio communications in the same building where the UE 502 is located.

### 3.1.1.5 Network-Deployment and Cell-Configuration Association of Multiple UL Transmit Power Levels

The need for using multi-level UL transmit power control may arise in specific deployments, e.g., in large macro cells where the UE transmission quality may become UE power-limited and it thus may be desirable to enable low-interference time intervals to facilitate certain, e.g., most sensitive to the interference, transmissions of macro cell-edge UEs. In such low-interference time intervals, there may be UL transmit power restrictions on high-power UE transmissions in some neighbor cells, e.g., in cells associated with low-power nodes operating with extended cell range within the macro cell coverage.

Another application example is that with macro-femto deployments, e.g., where femto nodes are CSG nodes serving the CSG cells.

### 3.1.1.6 Victim RAT Association of the Multiple UL Transmit Power Levels

It is known in the prior art that the UE may be configured to transmit at a lower than its maximum output power to avoid or minimize the interference towards another systems. The other systems may typically operate in a carrier or frequency band which is adjacent to or closer to the frequency/band of the UE. The other systems may belong to the same RAT as that of the UE or to a different RAT/technology.

Examples of typical scenarios where the UE may be configured to operate at lower maximum output power are: small cells such as pico, femto, micro etc, close to a sensitive location e.g. hospital. The embodiments herein enhance the prior-art approach by restricting the use of the UE transmit power to certain time resources. Some embodiments herein enhance the prior-art approach by restricting the use of the UE transmit power to certain time/frequency resources.

### 3.1.2. Zero and Non-Zero Transmit Power Levels

In the prior art, it is not possible to configure zero-power (in linear scale) or very low or infinitely low power (e.g., to account for transmitter leakage when in ‘ON’ state) transmissions which is taken care of by the scheduler controlled by the network. Herein, such transmissions are referred to as zero-power transmissions.

Some embodiments herein allow for configuring zero-power transmissions, in a special example, which may correspond to one of the multiple (more than one) UL transmit power strategies/levels described in Section 3.1.1, wherein the power strategies may be reducing or boosting the transmit power. Some non-limiting application examples are the following:
to avoid UL transmissions in some time-frequency resources (e.g., for interference coordination purpose) out of those configured by an UL transmission pattern, e.g., persistent or semi-persistent scheduling pattern;
to apply a certain cell-level UL transmission power strategy or the strategy applicable for UEs in a certain area or associated with a certain group, which gives more flexibility to network-controlled interference coordination since unnecessary UE-specific UL transmission reconfiguration can be avoided.

### 3.1.3 Best-Effort Transmissions in UL Transmit Patterns

In this embodiment, at least one of the configured multiple UL power transmission patterns may be associated with best-effort transmissions or congestion-based transmissions. For example, non-scheduled UEs or any UE belonging to a certain group may be allowed to perform transmissions in such time-frequency resources. It may also be up to the UE implementation whether to use or not such transmission occasions. Best-effort transmissions may be associated with no guaranteed performance or no requirements e.g., in 3GPP TS 36.133.

3.1.4 Network Elements that May Need to be Aware of Multi-Level UL Transmit Power Control

The following network elements may be involved directly or indirectly in multi-level UL transmit power control:
UEs (in the most general sense, i.e., including radio nodes, etc.) which transmit in UL and receive UL transmit power configuration from another node (e.g., from the serving/primary cell, from a network node such as MDT node or positioning node);
Radio nodes (e.g., eNodeBs) which control/configure the UL transmit power of the said UEs and communicate the UL transmit power configuration to the said UEs;
Radio nodes performing measurements on UL transmissions which may need to be informed (e.g., by another radio node or coordinating network node) about UL transmissions to be measured, where the said radio node may be one or more of the following, e.g.:
   Non-serving radio nodes, or
   Serving radio nodes not co-located with the primary cell (e.g., with distributed antenna systems or CoMP), or
   Donor nodes controlling the relay node in relay environment,
   LMUs 505, or
   NodeBs coordinated by RNC;
Coordinating network nodes that control, at least in part, the operation of the said radio nodes, where the coordinating network node may be, e.g.,
   Femto gateways coordinating femto base stations,
   RNC coordinating NodeBs in UTRAN,
   Core network node (e.g., SON node, O&M, an RRM node, an MDT node) coordinating, at least in part (i.e., some functionality), the said eNodeBs,
   Another radio node coordinating the said radio nodes (e.g., a macro radio node coordinating smaller base stations in the area of its coverage or an eNodeB communicating the UL transmission configuration to the associated UL measurement units such as distributed receive antennas or LMUs 505),
   Positioning node 506 coordinating UL radio measurement nodes such as LMUs 505 or eNodeBs;
Network nodes that may need to be informed about UL transmission configuration, e.g.:
   Positioning node 506 (e.g., when it is responsible for selecting measuring radio nodes such as LMUs 505) may need to be informed by eNodeBs,
   SON node or O&M node may need to be informed by eNodeBs,
   UL measurement units (e.g., distributed receive units or LMUs) may need to be informed by the associated radio node or by the coordinating node (see above).

In the communications described above, any of the information related to the multi-level UL power control (e.g., such as discussed in Sec. 3.1.5) is communicated between at least two network elements over the relevant interfaces, e.g., X2 (between eNodeBs), RRC (between UE and radio node), LPPa (between eNodeB and positioning node such as E-SMLC in LTE), LPP between UE and positioning node, etc. The information related to the multi-level UL power control is described in more detail in Section 3.1.5.

The information may be specific to a UE, a group of UE or all UEs in a cell and may be communicated via lower-layer signaling (e.g., broadcast, multicast or dedicated control signaling) or higher-layer signaling (e.g., RRC, LPPa, LPP), where the signaling may be dedicated, multi-cast or broadcast. The examples of broadcast and multicast signaling via higher-layer protocols are SIB (System Information Block) and MIB (Master Information Block) transmitted over RRC [1].

3.1.5 Network Element Capability Associated with the Multi-Level UL Power Control

A specific capability associated with the ability to support the multi-level UL power control may be defined for network elements such as UE 502 or radio nodes 504 (e.g. UE or a node supports first power control and second power control).

The UE 502 may report its multi-level UL power control capability to the network nodes. Examples of network nodes are eNB, positioning node, relay node, donor relay node etc.

The multi-level UL power control capability may be defined for specific channels (e.g. RACH or for all channels such as RACH, PUCCH, PUSCH, SRS etc). This applies to all network elements.

For example the UE 502 may report its multi-level UL power control capability per channel or as one capability for all channels to the network node.

The radio network node capability of supporting the multi-level UL power control may be exchanged among the network elements. For example the first radio network node may report its capability to the second radio network node (e.g. neighboring nodes) or to another network node (e.g., to positioning node over LPPa).

The radio node 504 or any other network node 506 receiving the UE capability may forward the received capability to another radio node or network node. For example the serving eNB can report the received UE capability to a neighboring eNB over X2.

The first node receiving the multi-level UL power control capability of the UE or any radio node may send request to the target node to send its capability. The multi-level UL power control capability may also be send by the UE or by the radio node to the first node proactively i.e. without receiving any specific requests.

The receiving node will use the received capability for setting the appropriate power control scheme (e.g. first or second or both) depending upon the capability of the network elements or configuring measurements while taking into account such capability.

Capability may also be implicitly defined, e.g. associated with a UE release and be required for that release, so some UEs 502 will have it but earlier UE will not.

### 3.1.6 the Information Related to the Multi-Level UL Power Control

The information related to the multi-level UL power control may be UE specific, UE group specific, or common for all UEs in a cell. Further, the information may be cell-specific, may be specific for certain group of radio nodes, e.g. corresponding to a certain power class, and it may be common for all or a group of cells in the network. Conditions, as described below, may be used to restrict the applicability of the multi-level UL power control or its certain power levels.

The information related to the multi-level UL power control may comprise (but not limited to) one or more of:
Implicit (e.g., a pre-defined rule) or explicit indication of channels/signals subject to multi-level UL power control,
   The applicability may be for all UL transmission types from the same UE 502 or for a specific channel/signal in the indicated UL time-frequency resources,
A set of indicated time and/or frequency resources when at least one of the multiple levels of UL transmit power apply, where the set of time and/or frequency resources may comprise. e.g.,
   UL transmission pattern associated with a specific UL transmit power level,
   Carrier frequency or frequency band,
   Part of the bandwidth
A set of conditions (e.g., a threshold and the associated rule) when the at least one of the multiple levels of UL transmit power apply, where the condition determines whether multi-level UL power control applies for a specific UE or a group of UEs and where the said conditions may e.g. be related to
   Radio signal characterization of the serving and/or neighbor cell (e.g., signaling strength, signal quality, interference, noise), where the characterization may e.g. be a certain threshold indicating the applicability of the multi-level UL power control,
      E.g. a specific UL power level may be configured for UEs close to a victim radio node such as femto BS or other small BSs.
   Other performance characterization of the serving and/or neighbor cell (e.g., cell load, resource utilization, number of UEs, number of UEs of specific traffic type e.g. number of GBR UEs or VoIP UEs), where the characterization may e.g. be a certain threshold indicating the applicability of the multi-level UL power control,
   Traffic type or service type or bearer type characterization (e.g., associated with the requested QoS),
      E.g., configuring UL higher-power transmission subframes for UL (e.g. SRS) transmissions for a specific purpose (in UL positioning subframes or for the UTDOA measurements),
   Geographical location or a part of the serving cell coverage area,
   Environment (e.g., indoor, outdoor, LOS-like, rich multipath, etc.),
   Neighbor cell configuration (e.g., frequency, RAT, power class of the associated radio node);
   The way the UL transmission has been initiated, e.g., whether the RA procedure has been initiated by PDCCH or MAC sublayer itself.
   Message format,
   Transmission counter or at least it can be different for the first transmission and a next transmission,
   Random Access Preambles group or other UE group indication.
Parameters associated with uplink received signal target i.e. desired signal target to be achieved at the base station.
   Examples of UL received signal targets for different channels/signals are:
      Target preamble received power for PRACH (PREAMBLE_RECEIVED_TARGET_POWER);
      Target received power for PUCCH (P_{O}_{_{—}}_{UE}_{_{—}}_{PUCCH})
      Target received power for PUSCH in subframe j (P_{O}_{_{—}}_{PUSCH, c}(j))
      Power offset for SRS (P_{SRS}_{_{—OFFSET, c}}(m))
   In one embodiment absolute values of the uplink received signal target is signaled to the UE for each power control loop e.g.
      As an example for controlling the UE power for the first and second PRACH transmissions, first PREAMBLE_RECEIVED_TARGET_POWER and second PREAMBLE_RECEIVED_TARGET_POWER respectively are signaled to the UE by the network node.
   In second embodiment relative values of the uplink received signal target is signaled to the UE for each power control loop. The relative values are derived from a reference value. The reference value may be a pre-defined value or it may be the value associated with the target power level for the first power control or it may be the value associated with the target power level for one of the power control loops. This is explained with examples:
      As an example for controlling the UE power for the first and second PRACH transmissions, first (PREAMBLE_RECEIVED_TARGET_POWER−REF) and second (PREAMBLE_RECEIVED_TARGET_POWER−REF) respectively are signaled to the UE by the network node. The signaled values are in dB but can also be in linear scale.
      In another example for controlling the UE power for the first and second PRACH transmissions, first (PREAMBLE_RECEIVED_TARGET_POWER) and OFFSET_PREAMBLE_RECEIVED_TARGET_POWER respectively are signaled to the UE by the network node. The OFFSET_PREAMBLE_RECEIVED_TARGET_POWER is expressed as:
         (First PREAMBLE_RECEIVED_TARGET_POWER−Second PREAMBLE_RECEIVED_TARGET_POWER)
         The signaled values are in dB but may also be in linear scale.

### 3.1.7 Methods of Configuring Multi-Level UL Transmit Power Control

3.1.7.1 an Example Method in a Radio Node 504 (e.g., eNodeB)

An example method in a first radio node 504 associated with a UE 502 or a group of UEs, may comprise the following steps:
determining the link (e.g., receiving radio node, frequency, RAT, etc.) for UL transmissions that may need multi-level UL power control,
determining the first type of channel/signal that can require the multi-level UL power control,
determining the need for the multi-level UL power control for the determined channel/signal, and
determining the UE 502 ability to support the multi-level UL power control.
if there is also a need for specific time-frequency resources associated with the second UL power control is identified:
   determining the first set of UL restricted time-frequency resources, and
   requesting configuring the first set of UL restricted time-frequency resources in the second radio node,
if there is also a need for specific time-frequency resources associated with the third UL power control is identified:
   determining the second set of UL restricted time-frequency resources,
   request configuring the second set of UL restricted time-frequency resources in the second radio node,
determining and configuring parameters and conditions for at least the second UL power control for a UE 502 or a group of UEs,
receiving UL transmission on the first channel/signal from the said UE 502 or group of UEs,
performing UL measurement on the received UL transmission, and
updating the parameters of the UL power control in the second UL power control loop for the said UE 502 or the group of UEs.

If there is no more need for the configured first and/or second time-frequency resources that require specific transmission mode in the second radio node, the method includes indicating to the second node that there is no further need in the configured first and/or second time-frequency resources.

### 3.1.7.2 an Example Method in a Network Node 506 (e.g., Positioning Node)

An example method in a network node 506, may comprise the following steps:
Determining the link (e.g., receiving radio node, frequency, RAT, etc) for UL transmissions that can need multi-level UL power control,
Determining the first type of channel/signal that may require the multi-level UL power control,
Determining whether the first radio node and/or the target UE are capable of supporting multi-level UL power control
If also a need for specific time-frequency resources associated with the second UL power control is identified,
   determine the first set of UL restricted time-frequency resources;
   request configuring the first set of UL restricted time-frequency resources from the second radio node
   request the first radio node to configure the UL measurement for a UE 502 or a group of UEs
optionally, indicate to the first radio node the need for the multi-level UL power control for the UE 502
Receive UL measurements from
   the said UE 502 or at least one UE from the group of the UEs, or
   the first radio node.

### 3.1.8 UE Behavior and Selection Criteria

According to this aspect of embodiments described herein, the UE 502 behavior of handling at least two power control loops (first and second power control) for the same type of channel/signal is pre-defined.

The UE 502 will use the separate set of parameters associated with each power control for performing the power control. Hence, a control unit in the UE 502 determines prior to the next time instant for transmission whether the first or second (or third etc) power control should be applied. The UE 502 adapts the transmission power, by adjusting the gain in the transmitter and/or power amplifier according to the parameters determined for the current used power control loop.

The UE 502 is preferably capable of receiving multiple set of configuration parameters associated with each power control loop for the same type of channel/signals, interpreting the received parameters associated with each power control, and performing the uplink power control based on the received configuration.

The UE 502 behavior in terms of criteria for transmitting using first and second power control loops for the same type of channel/signal can also be pre-defined. Several examples of criteria for selecting the first or second power control loops are provided.

For example, it may be specified that the UE 502 performs first or second power control provided an offset between the signals in the normal subframes and in the restricted subframes differs by certain threshold (φ). The threshold may be pre-defined or configured by the network node. The offset may also be multiple level e.g. φ1 and φ2. The threshold may be the same or different for different type of channel/signals. The selection offset (Soffet) may be derived from the received signal target or from the estimated transmit power levels.

In one example for the RACH the criteria for selecting the first or second power control for RA transmission may be derived using the received target power levels, e.g., First PREAMBLE_RECEIVED_TARGET_POWER for first power control loop on PRACH, and Second PREAMBLE_RECEIVED_TARGET_POWER for second power control loop on PRACH. Furthermore the Soffset may be expressed in dB as:

Soffset=First_PREAMBLE_RECEIVED_TARGET_POWER_for_first_power_control_loop on PRACH−Second_PREAMBLE_RECEIVED_TARGET_POWER_for_second_power_control_loop_on_PRACH+δ.

For example, if Soffset>φ1, then the UE 502 performs only the second random access; if Soffset<φ2, then the UE 502 performs only the first random access; else, the UE 502 may perform either the first or second random access.

In a second example for the RACH, the criteria for selecting the first or second power control for RA transmission may be derived using the estimated power for first and second power control loops. For example, if Soffset=(P_{PRACH}_{_{—}}₁−P_{PRACH}_{_{—}}₂)>Δ1, then the UE performs only second random access using parameters associated with the second PC loop; if Soffset=(P_{PRACH}_{_{—}}₁−P_{PRACH}_{_{—}}₂)<Δ2, then the UE performs only first random access using parameters associated with the first PC loop; else, the UE 502 may perform either first or second random access.

The UE 502 may also be configured by the network node as to which criteria is used for selection of the power control scheme.

In a third example, the UE 502 selects a lower UL power level and/or the indicated time-frequency resources for transmitting a channel/signal when the UE 502 is in proximity to a potential victim node, e.g. receiving a relatively strong signal (e.g., above the threshold) from a CSG.

In yet a fourth example, the criteria for selecting the first or second power control for random access transmission may be derived based on pre-defined rule associated with a UE measure and signaled parameters. More specifically the selection criteria may be based on the comparison between the UE measurement quantity and the threshold. More than one measure may also be used for the selection criteria. The UE measure may be pre-defined or may be configured by the network. Examples of UE measures are: path loss (PL; DL or UL), path gain, signal strength (e.g. RSRP), signal quality (e.g. RSRQ), propagation delay, UE transmit power, distance between UE 502 and base station to which RA is to be done etc. The threshold may be pre-defined or signaled by the network.

Consider one example where the measurement may be path loss (PL). For instance, if the UE estimated PL is above a threshold, then the UE 502 may use either the first random access or second random access; else, the UE 502 uses only second random access.

In another variant of the fourth example, if the distance (or propagation delay) is smaller than the corresponding threshold, the UE 502 may choose any scheme (i.e. first or second) otherwise it uses the second random access.

### 3.1.9 Applicability to Advanced System Deployments

Embodiments of the present invention (i.e. multi-level power control, associated signalling and methods) apply also to advanced deployment scenarios and in particular UL transmissions (the UL transmissions include also backhaul transmissions in UL) in, e.g.
Distributed antenna systems (DAS) aka CoMP or RRH,
Multi-carrier systems in general,
Carrier Aggregation (CA) systems, including intra-band, intra-band non-contiguous, inter-band and inter-RAT CA systems,
DL CoMP, UL CoMP,
Heterogeneous network deployments with low-power nodes, e.g., micro, pico, femto BSs, BSs with the maximum transmit power levels below 20 dBm, relay nodes or mobile relay nodes,
Systems with multifarious links, e.g., as described in [7].
Relay backhaul (e.g. between donor node and relay); single carrier as well as multi-carrier deployment

### Positioning Architecture in LTE

In LTE positioning architecture, the three key network elements are the LCS Client, the LCS target and the LCS Server. The LCS Server is a physical or logical entity managing positioning for a LCS target device by collecting measurements and other location information, assisting the terminal in measurements when necessary, and estimating the LCS target location. A LCS Client is a software and/or hardware entity that interacts with a LCS Server for the purpose of obtaining location information for one or more LCS targets, i.e. the entities being positioned. LCS Clients may reside in the LCS targets themselves. An LCS Client sends a request to LCS Server to obtain location information, and LCS Server processes and serves the received requests and sends the positioning result and optionally a velocity estimate to the LCS Client. A positioning request may be originated from the terminal or the network.

Position calculation may be conducted, for example, by a positioning server (e.g. E-SMLC or SLP in LIE) or UE. The former approach corresponds to the UE-assisted positioning mode, whilst the latter corresponds to the UE-based positioning mode. Two positioning protocols operating via the radio network exist in 3GPP LTE, LPP and LPPa. The LPP is a point-to-point protocol between a LCS Server and a LCS target device, used in order to position the target device. LPP may be used both in the user and control plane, and multiple LPP procedures are allowed in series and/or in parallel thereby reducing latency. LPPa is a protocol between eNodeB and LCS Server specified only for control-plane positioning procedures, although it still may assist user-plane positioning by querying eNodeBs for information and eNodeB measurements. SUPL protocol is used as a transport for LPP in the user plane. LPP has also a possibility to convey LPP extension messages inside LPP messages, e.g., currently OMA LPP extensions are being specified (LPPe) to allow, e.g., for operator- or manufacturer-specific assistance data or assistance data that may not be provided with LPP or to support other position reporting formats or new positioning methods. LPPe may also be embedded into messages of other positioning protocol, which is not necessarily LPP.

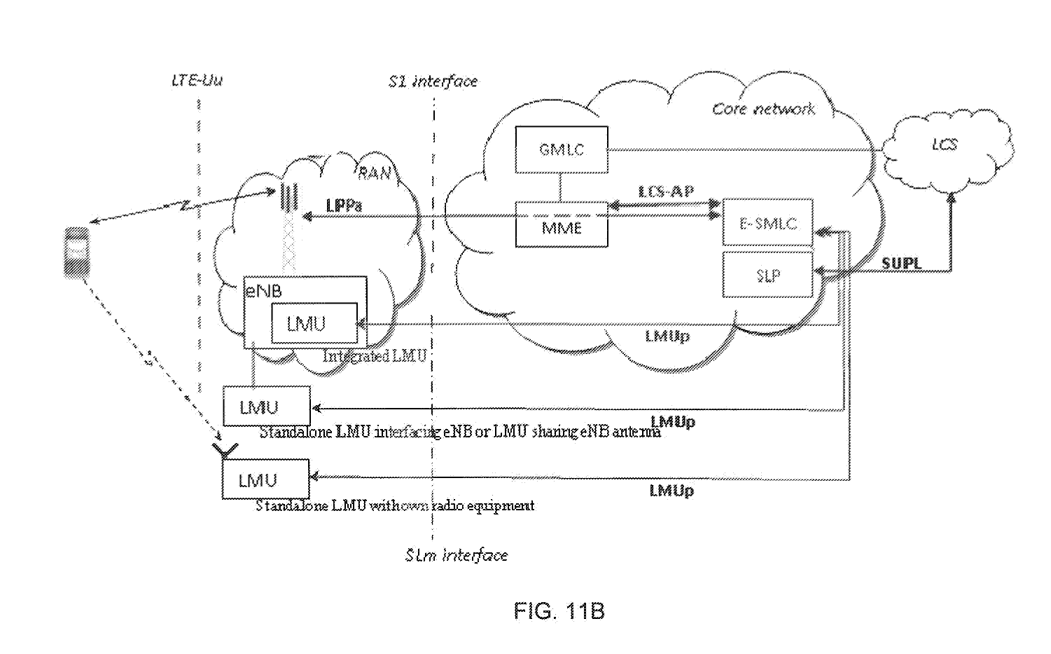

A high-level architecture, as it is currently standardized in LTE, is illustrated in FIG. 11A, where the LCS target is a terminal, and the LCS Server is an E-SMLC or an SLP. In the figure, the control plane positioning protocols with E-SMLC as the terminating point are shown in blue, and the user plane positioning protocol is shown in red. SLP may comprise two components, SPC and SLC, which may also reside in different nodes. In an example implementation, SPC has a proprietary interface with E-SMLC, and Llp interface with SLC, and the SLC part of SLP communicates with P-GW (PDN-Gateway) and External LCS Client.

Additional positioning architecture elements may also be deployed to further enhance performance of specific positioning methods. For example, deploying radio beacons is a cost-efficient solution which may significantly improve positioning performance indoors and also outdoors by allowing more accurate positioning, for example, with proximity location techniques. As previously mentioned, the three key network elements in an LTE positioning architecture are the LCS Client, the LCS target and the LCS Server. The LCS Server is a physical or logical entity managing positioning for a LCS target device by collecting measurements and other location information, assisting the terminal in measurements when necessary, and estimating the LCS target location. A LCS Client is a software and/or hardware entity that interacts with a LCS Server for the purpose of obtaining location information for one or more LCS targets, i.e. the entities being positioned. LCS Clients may reside in a network node, external node, PSAP, UE, radio base station, etc., and they may also reside in the LCS targets themselves. An LCS Client (e.g., an external LCS Client) sends a request to LCS Server (e.g., positioning node) to obtain location information, and LCS Server processes and serves the received requests and sends the positioning result and optionally a velocity estimate to the LCS Client. Further, as previously mentioned, position calculation may be conducted, for example, by a positioning server (e.g. E-SMLC or SLP in LTE) or UE. The latter corresponds to the UE-based positioning mode, whilst the former may be network-based positioning (calculation in a network node based on measurements collected from network nodes such as LMUs or eNodeBs) or UE-assisted positioning (calculation is in a positioning network node based on measurements received from UE). FIG. 11B illustrates the UTDOA architecture being currently discussed in 3GPP. Although UL measurements may in principle be performed by any radio network node (e.g., eNodeB), UL positioning architecture may include specific UL measurement units (e.g., LMUs) which e.g. may be logical and/or physical nodes, may be integrated with radio base stations or sharing some of the software or hardware equipment with radio base stations or may be completely standalone nodes with own equipment (including antennas). The architecture is not finalized yet, but there may be communication protocols between LMU and positioning node, and there may be some enhancements for LPPa or similar protocols to support UL positioning. A new interface, SLm, between the E-SMLC and LMU is being standardized for uplink positioning. The interface is terminated between a positioning server (E-SMLC) and LMU. It is used to transport LMUp protocol (new protocol being specified for UL positioning, for which no details are yet available; in some sources it is also referred to as SLmAP protocol) messages over the E-SMLC-to-LMU interface. Several LMU deployment options are possible. For example, an LMU may be a standalone physical node, it may be integrated into eNodeB or it may be sharing at least some equipment such as antennas with eNodeB—these three options are illustrated in the FIG. 11B. LPPa is a protocol between eNodeB and LCS Server specified only for control-plane positioning procedures, although it still can assist user-plane positioning by querying eNodeBs for information and eNodeB measurements. In LTE, UTDOA measurements, UL RTOA, are performed on Sounding Reference Signals (SRS). To detect an SRS signal, LMU needs a number of SRS parameters to generate the SRS sequence which is to be correlated to receive signals. SRS parameters would have to be provided in the assistance data transmitted by positioning node to LMU; these assistance data would be provided via LMUp. However, these parameters are generally not known to the positioning node, which needs then to obtain this information from eNodeB configuring the SRS to be transmitted by the UE and measured by LMU; this information would have to be provided in LPPa or similar protocol.

Positioning methods and measurements that may be used for positioning maybe determined in several ways. To meet LBS demands, the LTE network will deploy a range of complementing methods characterized by different performance in different environments. Depending on where the measurements are conducted and the final position is calculated, the methods may be UE-based, UE-assisted or network-based, each with own advantages. The following methods are available in the LTE standard for both the control plane and the user plane,
Cell ID (CID),
UE-assisted and network-based E-CID, including network-based angle of arrival (AoA),
UE-based and UE-assisted A-GNSS (including A-GPS),
UE-assisted Observed Time Difference of Arrival (OTDOA).

Hybrid positioning, fingerprinting positioning/pattern matching and adaptive E-CID (AECID) do not require additional standardization and are therefore also possible with LTE. Furthermore, there may also be UE-based versions of the methods above, e.g. UE-based GNSS (e.g. GPS) or UE-based OTDOA, etc. There may also be some alternative positioning methods such as proximity based location. UTDOA may also be standardized in a later LTE release, since it is currently under discussion in 3GPP.

Similar methods, which may have different names, also exist in other RATs, e.g., CDMA, WCDMA or GSM.

LTE uses orthogonal frequency division multiplex (OFDM) in the downlink (DL) from an eNB to user equipments (UEs), or terminals, in its cell, and discrete Fourier transform (DFT)-spread OFDM in the uplink (UL) from a UE to an eNB. LTE communication channels are described in 3GPP Technical Specification (TS) 36.211 V9.1.0, Physical Channels and Modulation (Release 9) (December 2009) and other specifications. For example, control information exchanged by eNBs and UEs is conveyed by physical uplink control channels (PUCCHs) and by physical downlink control channels (PDCCHs).

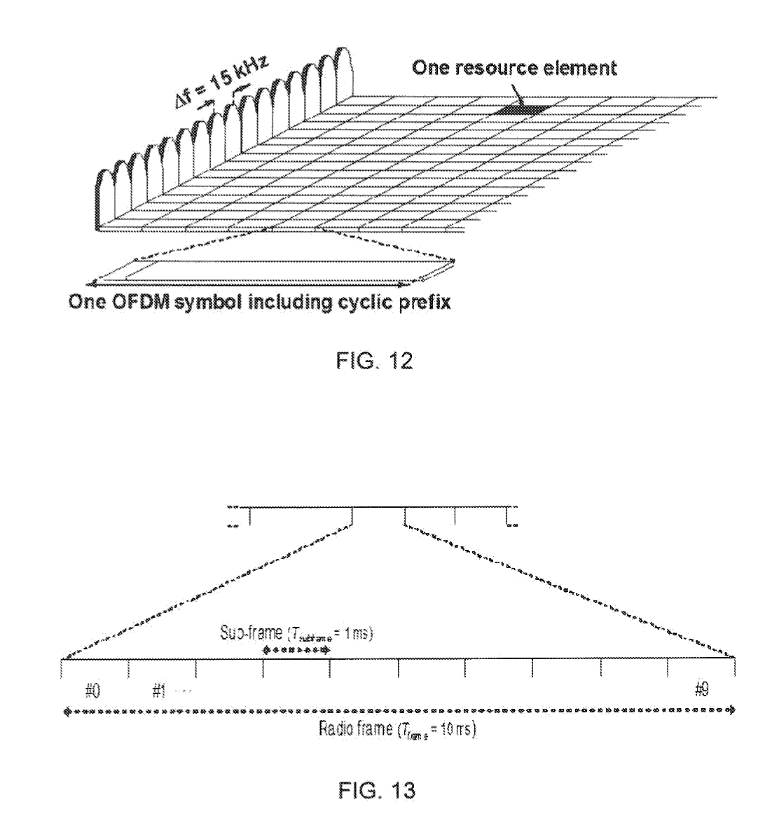

FIG. 12 depicts the basic LTE DL physical resource as a time-frequency grid of resource elements (REs), in which each RE spans one OFDM subcarrier (frequency domain) for one OFDM symbol (time domain). The subcarriers, or tones, are typically spaced apart by fifteen kilohertz (kHz). In an Evolved Multicast Broadcast Multimedia Services (MBMS) Single Frequency Network (MBSFN), the subcarriers are spaced apart by either 15 kHz or 7.5 kHz. A data stream to be transmitted is portioned among a number of the subcarriers that are transmitted in parallel. Different groups of subcarriers can be used at different times for different purposes and different users.

FIG. 13 generally depicts the organization over time of an LTE DL OFDM carrier in the frequency division duplex (FDD) mode of LTE according to 3GPP TS 36.211. The DL OFDM carrier comprises a plurality of subcarriers within its bandwidth as depicted in FIG. 12, and is organized into successive frames of 10 milliseconds (ms) duration. Each frame is divided into ten successive subframes, and each subframe is divided into two successive time slots of 0.5 ms. Each slot typically includes either six or seven OFDM symbols, depending on whether the symbols include long (extended) or short (normal) cyclic prefixes.

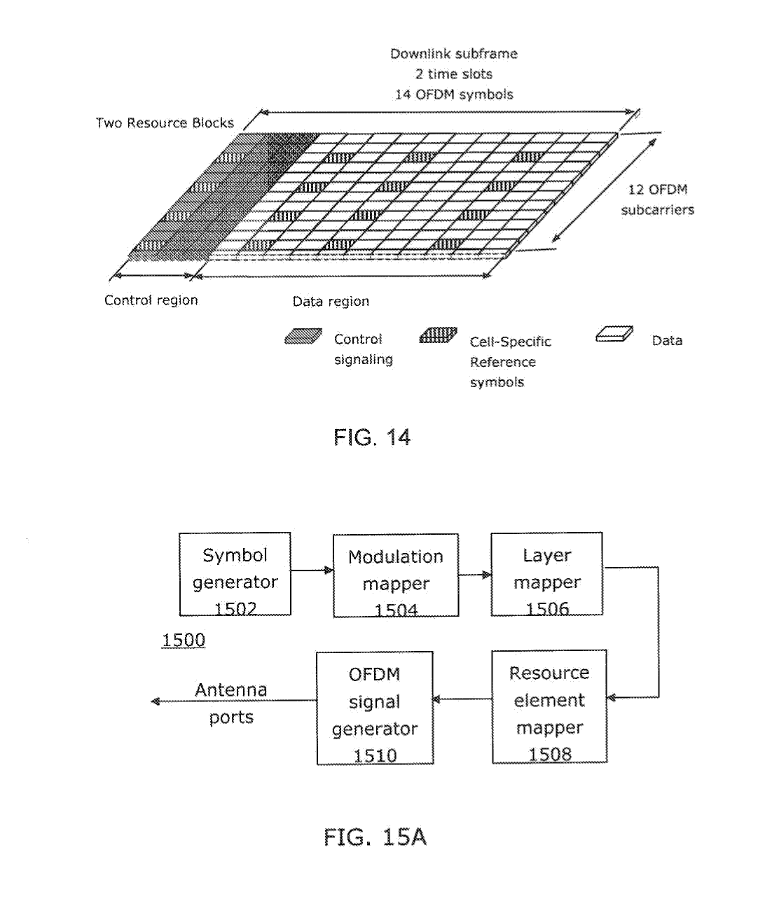

FIG. 14 also generally depicts the LTE DL physical resource in terms of physical resource blocks (PRBs, or RBs), with each RB corresponding to one slot in the time domain and twelve 15-kHz subcarriers in the frequency domain. Resource blocks are consecutively numbered within the bandwidth of an OFDM carrier, starting with 0 at one end of the system bandwidth. Two consecutive (in time) resource blocks represent a resource block pair and correspond to two time slots (one subframe, or 0.5 ms).

Transmissions in LTE are dynamically scheduled in each subframe, and scheduling operates on the time interval of a subframe. An eNB transmits assignments/grants to certain UEs via a PDCCH, which is carried by the first 1, 2, 3, or 4 OFDM symbol(s) in each subframe and spans over the whole system bandwidth. A UE that has decoded the control information carried by a PDCCH knows which resource elements in the subframe contain data aimed for the UE. In the example depicted by FIG. 14, the PDCCHs occupy just the first symbol of three symbols in a control region of the first RB. In this particular case, therefore, the second and third symbols in the control region can be used for data.

The length of the control region, which may vary from subframe to subframe, is signaled to the UEs through a physical control format indicator channel (PCFICH), which is transmitted within the control region at locations known by the UEs. After a UE has decoded the PCFICH, it knows the size of the control region and in which OFDM symbol data transmission starts. Also transmitted in the control region is a physical hybrid automatic repeat request (ARQ) indicator channel (PHICH), which carries acknowledged/not-acknowledged (ACK/NACK) responses by an eNB to granted uplink transmission by a UE that inform the UE about whether its uplink data transmission in a previous subframe was successfully decoded by the eNB or not.

Coherent demodulation of received data requires estimation of the radio channel, which is facilitated by transmitting reference symbols (RS), i.e., symbols known by the receiver. Acquisition of channel state information (CSI) at the transmitter or the receiver is important to proper implementation of multi-antenna techniques. In LTE, an eNB transmits cell-specific reference symbols (CRS) in all DL subframes on known subcarriers in the OFDM frequency-vs.-time grid. CRS are described in, for example, Clauses 6.10 and 6.11 of 3GPP TS 36.211. A UE uses its received versions of the CRS to estimate characteristics, such as the impulse response, of its DL channel. The UE may then use the estimated channel matrix (CSI) for coherent demodulation of the received DL signal, for channel quality measurements to support link adaptation, and for other purposes. LTE also supports UE-specific reference symbols for assisting channel estimation at eNBs.

Before an LTE UE may communicate with the LTE network, i.e., with an eNB, the UE has to find and synchronize itself to a cell (i.e., an eNB) in the network, to receive and decode the information needed to communicate with and operate properly within the cell, and to access the cell by a so-called random-access procedure. The first of these steps, finding a cell and syncing to it, is commonly called cell search.

Cell search is carried out when a UE powers up or initially accesses a network, and is also performed in support of UE mobility. Thus, even after a UE has found and acquired a cell, which may be called its serving cell, the UE continually searches for, synchronizes to, and estimates the reception quality of signals from cells neighboring its serving cell. The reception qualities of the neighbor cells, in relation to the reception quality of the serving cell, are evaluated in order to determine whether a handover (for a UE in Connected mode) or a cell re-selection (for a UE in Idle mode) should be carried out. For a UE in Connected mode, the handover decision is taken by the network based on reports of DL signal measurements provided by the UE. Examples of such measurements are reference signal received power (RSRP) and reference signal received quality (RSRQ).

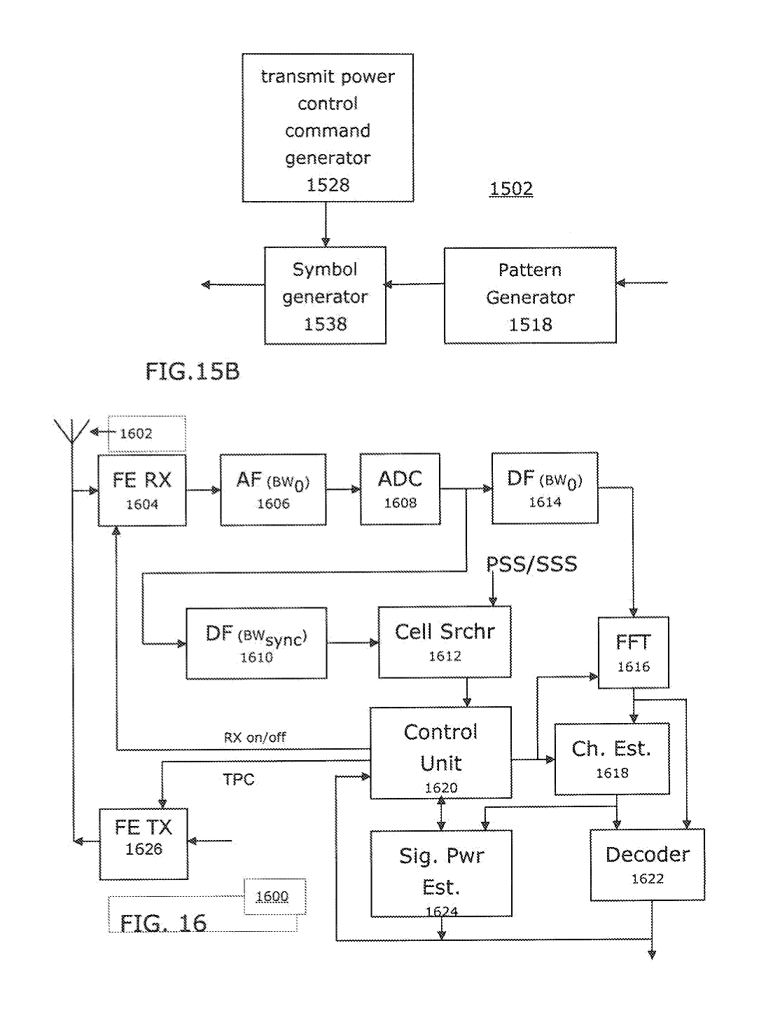

FIG. 15A is a block diagram of an example of a portion of transmitter 1500 for an eNB or other transmitting node of a communication system that uses the signals described above. Several parts of such a transmitter are known and described for example in Clauses 6.3 and 6.4 of 3GPP TS 36.211. Reference signals having symbols as described above are produced by a suitable generator 1502 and provided to a modulation mapper 1504 that produces complex-valued modulation symbols. A layer mapper 1506 maps the modulation symbols onto one or more transmission layers, which generally correspond to antenna ports. A resource element (RE) mapper 908 maps modulation symbols for each antenna port onto respective REs and thus forms successions of RBs, subframes, and frames, and an OFDM signal generator 1510 produces one or more complex-valued time-domain OFDM signals for eventual transmission. It will be appreciated that the node 1700 may include one or more antennas for transmitting and receiving signals, as well as suitable electronic components for receiving signals and handling received signals as described above.

It will be appreciated that the functional blocks depicted in FIG. 15A may be combined and re-arranged in a variety of equivalent ways, and that many of the functions may be performed by one or more suitably programmed digital signal processors. Moreover, connections among and information provided or exchanged by the functional blocks depicted in FIG. 15A may be altered in various ways to enable a device to implement the methods described above and other methods involved in the operation of the device in a digital communication system.

FIG. 15B is a more detailed block diagram of an example of a symbol generator 1502 in accordance with this invention. As depicted in FIG. 15B, the generator 1502 is generally an electronic signal processor that is configured to include a suitable pattern generator 1518, a transmit power control command generator 1528, and a final symbol generator 1538.

As described above, the generator 1518 maybe configured to include a timer or a counter that determines activation and re-activation points and cyclic shifts of a pattern, such as a pattern that results in varying temporal locations of transmission resource(s) having reduced transmission activity. The TPC command generator 1528 is configured for generating commands according to the methods and techniques described above.

FIG. 16 is a block diagram of an exemplifying arrangement 1600 in a UE that may implement the methods described above. It will be appreciated that the functional blocks depicted in FIG. 16 may be combined and re-arranged in a variety of equivalent ways, and that many of the functions may be performed by one or more suitably programmed digital signal processors. Moreover, connections among and information provided or exchanged by the functional blocks depicted in FIG. 16 may be altered in various ways to enable a UE to implement other methods involved in the operation of the UE.

As depicted in FIG. 16, a UE receives a DL radio signal through an antenna 1602 and typically down-converts the received radio signal to an analog baseband signal in a front end receiver (Fe RX) 1604. The baseband signal is spectrally shaped by an analog filter 1606 that has a bandwidth BW0, and the shaped baseband signal generated by the filter 1606 is converted from analog to digital form by an analog-to-digital converter (ADC) 1608.

The digitized baseband signal is further spectrally shaped by a digital filter 1610 that has a bandwidth BWsync, which corresponds to the bandwidth of synchronization signals or symbols included in the DL signal. The shaped signal generated by the filter 1610 is provided to a cell search unit 1612 that carries out one or more methods of searching for cells as specified for the particular communication system, e.g., LTE. Typically, such methods involve detecting predetermined primary and/or secondary synchronization channel (P/S-SCH) signals in the received signal.

The digitized baseband signal is also provided by the ADC 1808 to a digital filter 1614 that has the bandwidth BW0, and the filtered digital baseband signal is provided to a processor 1616 that implements a fast Fourier transform (FFT) or other suitable algorithm that generates a frequency-domain (spectral) representation of the baseband signal. A channel estimation unit 1618 receives signals from the processor 1616 and generates a channel estimate Hi, j for each of several subcarriers i and cells j based on control and timing signals provided by a control unit 1620, which also provides such control and timing information to the processor 1616.

The estimator 1618 provides the channel estimates Hi to a decoder 1622 and a signal power estimation unit 1624. The decoder 1622, which also receives signals from the processor 1616, is suitably configured to extract information from TPC, RRC or other messages as described above and typically generates signals subject to further processing in the UE (not shown). The estimator 1624 generates received signal measurements (e.g., estimates of RSRP, received subcarrier power, signal to interference ratio (SIR), etc.). The estimator 1624 may generate estimates of RSRP, RSRQ, received signal strength indicator (RSSI), received subcarrier power, SIR, and other relevant measurements, in various ways in response to control signals provided by the control unit 1620. Power estimates generated by the estimator 1624 are typically used in further signal processing in the UE.

As depicted in FIG. 16, the UE transmits a UL radio signal through the antenna 1602 that has been generated by up-conversion and controllable amplification in a front end transmitter (FE TX) 1626. The FE TX 1626 adjusts the power level of the UL signal based on a transmit power control signal provided by the control unit 1620.

The estimator 1624 (or the searcher 1612, for that matter) is configured to include a suitable signal correlator for handling reference and other signals.

In the arrangement depicted in FIG. 16, the control unit 1620 keeps track of substantially everything needed to configure the searcher 1612, processor 1616, estimation unit 1618, estimator 1624, and FE TX 1626. For the estimation unit 1618, this includes both method and cell ID (e.g., for reference signal extraction and cell-specific scrambling of reference signals). For the FE TX 1626, this includes power control signals corresponding to received TPC commands. Communication between the searcher 1812 and the control unit 1620 includes cell ID and, for example, cyclic prefix configuration.

The control unit 1620 determines which estimation method is used by the estimator 1618 and/or by the estimator 1624 for measurements on the detected cell(s) as described above. In particular, the control unit 1620, which typically may include a correlator or implement a correlator function, may receive information signaled by the eNB and can control the on/off times of the Fe RX 1604 and the transmit power level of the FE TX 1626 as described above.

The control unit and other blocks of the UE may be implemented by one or more suitably programmed electronic processors, collections of logic gates, etc. that processes information stored in one or more memories. The stored information may include program instructions and data that enable the control unit to implement the methods described above. It will be appreciated that the control unit typically includes timers, etc. that facilitate its operations.

In a general case, the embodiments described herein may apply to a serving cell, primary cell, any of secondary cells, where the cells may be on a frequency carrier, frequency band or RAT different from that of the serving/primary one. The embodiments may also apply to specific links, e.g., when a radio node, which is an intended receiver for the UL transmission, does not create a cell (e.g., a relay or RRU or an UL access point).

### 3.2 Advantages

Flexible UL interference coordination in time-frequency domain
Signaling means that enable multi-level UL power control that enables configuring multiple UL transmit power configurations for the same UE on the same channel/signal
Configuring UL transmit power patterns for higher-power transmissions and/or lower-power transmissions associated with the second UL power control
Defined UE behavior optimized to operate with multiple-level UL power control
Enhanced UL power control in advanced deployments

It will be appreciated that the methods and devices described above may be combined and re-arranged in a variety of equivalent ways, and that the methods may be performed by one or more suitably programmed or configured digital signal processors and other known electronic circuits (e.g., discrete logic gates interconnected to perform a specialized function, or application-specific integrated circuits). Many aspects of this invention are described in terms of sequences of actions that may be performed by, for example, elements of a programmable computer system. UEs embodying this invention include, for example, mobile telephones, pagers, headsets, laptop computers and other mobile terminals, and the like. Moreover, this invention may additionally be considered to be embodied entirely within any form of computer-readable storage medium having stored therein an appropriate set of instructions for use by or in connection with an instruction-execution system, apparatus, or device, such as a computer-based system, processor-containing system, or other system that may fetch instructions from a medium and execute the instructions.

It will be appreciated that procedures described above are carried out repetitively as necessary, for example, to respond to the time-varying nature of communication channels between transmitters and receivers. In addition, it will be understood that the methods and apparatuses described here may be implemented in various system nodes.

To facilitate understanding, many aspects of embodiments described herein are described in terms of sequences of actions that may be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both. Wireless devices implementing embodiments described herein may be included in, for example, mobile telephones, pagers, headsets, laptop computers and other mobile terminals, base stations, and the like.

Moreover, embodiments described herein may additionally be considered to be embodied entirely within any form of computer-readable storage medium having stored therein an appropriate set of instructions for use by or in connection with an instruction-execution system, apparatus, or device, such as a computer-based system, processor-containing system, or other system that may fetch instructions from a storage medium and execute the instructions. As used here, a “computer-readable medium” may be any means that may contain, store, or transport the program for use by or in connection with the instruction-execution system, apparatus, or device. The computer-readable medium may be, for example but not limited to, an electronic, magnetic, optical, electromagnetic, infrared, or semiconductor system, apparatus, or device. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

### ABBREVIATIONS

### 3GPP Third Generation Partnership Project

### ABS Almost Blank Subframe

### BS Base Station

### CA Carrier Aggregation

### CRS Cell-specific Reference Signal

eICIC enhanced ICIC
eNodeB evolved Node B

### FDD Frequency Division Duplex

HeNB Home eNodeB

### ICIC Inter-Cell Interference Coordination

### LTE Long-Term Evolution

### MBMS Multimedia Broadcast and Multicast Service

### MBSFN MBMS Single Frequency Network

### PCI Physical Cell Identity

### PDCCH Physical Downlink Control Channel

### PRACH Physical Random Access Channel

### PUCCH Physical Uplink Control Channel

### PUSCH Physical Uplink Shared Channel

### RACH Random Access Channel

### RAT Radio Access Technology

### RRC Radio Resource Control

### RSRP Reference Signal Received Power

### SFN System Frame Number

### SINR Signal-to-Interference Ratio

### SRS Sounding Reference Signal

### TDD Time Division Duplex

### UE User Equipment

### UMTS Universal Mobile Telecommunications System

### REFERENCES

[1] 3GPP Technical Specification (TS) 36.331 V10.1.0, Evolved Universal Terrestrial Radio Access (E-UTRA); Radio Resource Control (RRC); Protocol specification (Release 10), March 2011.
[2] R1-102619, UL Power Control in Hotzone Deployments, 3GPP TSG RAN WG1 Meeting 61, Montreal, Canada, May 10-14, 2010, available at http://www.3gpp.org/ftp/tsg_ran/WG1_RL1/TSGR1_{—}61/Docs/R1-102619.zip.
[3] 3GPP TS 36.213 V10.1.0, Evolved Universal Terrestrial Radio Access (E-UTRA); Physical layer procedures (Release 10), March 2011.
[4] 3GPP TS 36.101 V10.2.1, Evolved Universal Terrestrial Radio Access (E-UTRA); User Equipment (UE) radio transmission and reception (Release 10), April 2011.
[5] 3GPP TS 36.321 V10.1.0, Evolved Universal Terrestrial Radio Access (E-UTRA); Medium Access Control (MAC) protocol specification (Release 10), March 2011.
[6] 3GPP TS 36.214 V10.1.0, Evolved Universal Terrestrial Radio Access (E-UTRA); Physical layer; Measurements (Release 10), March 2011.
[7] U.S. Provisional Patent Application No. 61/496,327 filed on Jun. 13, 2011, by I. Siomina et al. for “Methods and Apparatus for Configuring Enhanced Timing Measurements Involving Multifarious Links”, which is expressly incorporated by reference in this application.

1. A method in a wireless device for configuration of uplink power control, the method comprises:
obtaining a first set of uplink power control parameters and a second set of uplink power control parameters for transmitting a first type of signals, wherein the first set of uplink power control parameters is associated with a first set of time and/or frequency resources, and wherein the second set of uplink power control parameters is associated with a second set of time and/or frequency resources;
configuring transmissions of the first type of signals using the first set of uplink power control parameters when the transmissions are comprised in the first set of time and/or frequency resources; and
configuring transmissions of the first type of signals using the second set of uplink power control parameters when transmissions are comprised in the second set of time and/or frequency resources.

2. The method of claim 1, wherein the second set of uplink power control parameters comprises one or more of: UE-specific uplink power control parameters, UE-group specific uplink power control parameters, or cell-specific uplink power control parameters.

3. The method of claim 1, wherein the second set of time and/or frequency resources is comprised in a pattern.

4. The method of claim 1, wherein configuring the transmissions of the first type of signals using the second set of uplink power control parameters further comprises:
configuring the transmissions of the first type of signals using the second set of uplink power control parameters when one or more conditions are met, wherein a condition is determined by at least one of: the transmissions purpose, radio environment, interference condition, geographical location, signal type, resource type.

5. The method of claim 1, wherein the first and second sets of time and/or frequency resources are comprised in the same subframe.

6. The method of claim 1, wherein the first and second sets of time and/or frequency resources are comprised in different subframes.

7. The method of claim 1, wherein at least one of the first and second set of time and/or frequency resources is comprised in a part of the system bandwidth.

8. The method of claim 1, wherein the obtaining of at least the second set of uplink power control parameters comprises one or a combination of: receiving the second set of uplink power control parameters from a network node associated with the wireless device, configuring pre-defined values for the second set of uplink power control parameters, deriving the second set of uplink power control parameters based on a pre-defined rule, or deriving the second set of uplink power control parameters based on the first set of uplink power control parameters.

9. The method of claim 8, wherein the obtaining of the first set of uplink power control parameters and the second set of uplink power control parameters further comprises:
obtaining at least one of the first set of uplink power control parameters and the second set of uplink power control parameters by
receiving absolute values of an uplink received signal target, or
receiving relative values of the uplink received signal target, which relative values are derived from a reference value.

10. The method of claim 1, wherein at least some of the uplink power control parameters are pre-defined.

11. The method of claim 1, wherein the second set of time and/or frequency resources comprises restricted resources, which restricted resources of a cell overlap with low-interference time and/or frequency resources configured in an interfering neighbor cell; and wherein the first set of time and/or frequency resources comprises any of: restricted and non-restricted resources.

12. The method of claim 1, wherein the first type of signal is a physical uplink control channel, a physical uplink data channel, an uplink physical signal such as an uplink reference signal, or a physical random access channel.

13. The method of claim 1, further comprising:
transmitting to a network node a capability associated with the ability to support two sets of uplink power control parameters for uplink transmissions of the first type of signal.

14. The method of claim 1, further comprising:
transmitting the first type of signal using at least one of the first and second set of uplink power control parameters.

15. The method of claim 1, further comprising:
transmitting at least one of the first and second set of uplink power control parameters to a network node.

16. A wireless device for configuration of uplink power control, the wireless device comprises:
an obtaining circuit configured to obtain a first set of uplink power control parameters and a second set of uplink power control parameters for transmitting a first type of signals, wherein the first set of uplink power control parameters is associated with a first set of time and/or frequency resources, and wherein the second set of uplink power control parameters is associated with a second set of time and/or frequency resources;
a configuring circuit configured to configure transmissions of the first type of signals using the first set of uplink power control parameters when the transmissions are comprised in the first set of time and/or frequency resources; and wherein
the configuring circuit further is configured to configure transmissions of the first type of signals using the second set of uplink power control parameters when transmissions are comprised in the second set of time and/or frequency resources.

17. The wireless device of claim 16, wherein the second set of uplink power control parameters comprises one or more of: UE-specific uplink power control parameters, UE-group specific uplink power control parameters, or cell-specific uplink power control parameters.

18. The wireless device of claim 16, wherein the second set of time and/or frequency resources is comprised in a pattern.

19. The wireless device of claim 16, wherein the configuring circuit further is configured to configure the transmissions of the first type of signals using the second set of uplink power control parameters when one or more conditions are met, wherein a condition is determined by at least one of the transmissions purpose, radio environment, interference condition, geographical location, signal type, resource type.

20. The wireless device of claim 16, wherein the first and second sets of time and/or frequency resources are comprised in the same subframe.

21. The wireless device of claim 16, wherein the first and second sets of time and/or frequency resources are comprised in different subframes.

22. The wireless device of claim 16, wherein at least one of the first and second set of time and/or frequency resources is comprised in a part of the system bandwidth.

23. The wireless device of claim 16, wherein the obtaining circuit further is configured to receive the second set of uplink power control parameters from a network node associated with the wireless device, configure pre-defined values for the second set of uplink power control parameters, derive the second set of uplink power control parameters based on a pre-defined rule, or derive the second set of uplink power control parameters based on the first set of uplink power control parameters.

24. The wireless device of claim 23, wherein the obtaining circuit further is configured to obtaining at least one of the first set of uplink power control parameters and the second set of uplink power control parameters by
receiving absolute values of an uplink received signal target, or
receiving relative values of the uplink received signal target, which relative values are derived from a reference value.

25. The wireless device of claim 16, wherein at least some of the uplink power control parameters are pre-defined.

26. The wireless device of claim 16, wherein the second set of time and/or frequency resources comprises restricted resources, which restricted resources of a cell overlap with low-interference time and/or frequency resources configured in an interfering neighbor cell; and wherein the first set of time and/or frequency resources comprises any of: restricted and non-restricted resources.

27. The wireless device of claim 16, wherein the first signal is a physical uplink control channel, a physical uplink data channel, an uplink physical signal which may be an uplink physical reference signal, or a physical random access channel.

28. The wireless device of claim 16, further comprising:
a transmitting circuit configured to transmit to a network node a capability associated with the ability to support two sets of uplink power control parameters for uplink transmissions of the first type of signal.

29. The wireless device of claim 16, further comprising:
a transmitting circuit configured to transmit the first type of signal using at least one of the first and second set of uplink power control parameters.

30. The wireless device of claim 16, further comprising:
a transmitting circuit configured to transmit at least one of the first and second set of uplink power control parameters to a network node.

31. A method in a network node for configuration of uplink power control of a wireless device, the method comprises:
configuring or requesting configuration of a first set of uplink power control parameters for transmitting a first type of signals, which first set of uplink power control parameters is associated with a first set of time and/or frequency resources, wherein the first set of uplink power control parameters control of the wireless device's transmissions of the first type of signals when the transmissions are comprised in the first set of time and/or frequency resources;
configuring or requesting configuration of a second set of uplink power control parameters for transmitting the first type of signals, which second set of uplink power control parameters is associated with a second set of time and/or frequency resources, wherein the second set of uplink power control parameters control of the wireless device's transmissions of the first type of signals when the transmissions are comprised in the second set of time and/or frequency resources.

32. The method of claim 31, wherein the second set of uplink power control parameters comprises one or more of: UE-specific uplink power control parameters, UE-group specific uplink power control parameters, or cell-specific uplink power control parameters.

33. The method of claim 31, wherein the second set of time and/or frequency resources is comprised in a pattern.

34. The method of claim 31, wherein the first and second sets of time and/or frequency resources are comprised in the same subframe.

35. The method of claim 31, wherein the first and second sets of time and/or frequency resources are comprised in different subframes.

36. The method of claim 31, wherein at least one of the first and second set of time and/or frequency resources is comprised in a part of the system bandwidth.

37. The method of claim 31, wherein the uplink power control parameters are pre-defined.

38. The method of claim 31, wherein the second set of time and/or frequency resources comprises restricted resources, which restricted resources of a cell overlap with low-interference time and/or frequency resources configured in an interfering neighbor cell; and wherein the first set of time and/or frequency resources comprises any of: restricted and non-restricted resources.

39. The method of claim 31, wherein the first signal is a physical uplink control channel, a physical uplink data channel, an uplink physical signal which may be an uplink physical reference signal, or a physical random access channel.

40. The method of claim 31, further comprising:
transmitting the first and/or second sets of uplink power control parameters to the wireless device and/or another network node.

41. The method of claim 31, further comprising:
receiving from the wireless device a capability associated with the ability to support two sets of uplink power control parameters for uplink transmissions of the first type of signal.

42. The method of claim 31, further comprising:
receiving the first type of signal transmitted by the wireless device.

43. A network node for configuration of uplink power control of a wireless device, the network node comprises:
a configuring or requesting configuration circuit configured to configure or to request configuration of a first set of uplink power control parameters for transmitting a first type of signals, which first set of uplink power control parameters is associated with a first set of time and/or frequency resources, wherein the first set of uplink power control parameters control the wireless device's transmissions of the first type of signals when the transmissions are comprised in the first set of time and/or frequency resources; and wherein
the configuring or requesting configuration circuit further is configured to configure or to request configuration a second set of uplink power control parameters for transmitting the first type of signals, which second set of uplink power control parameters is associated with a second set of time and/or frequency resources, wherein the second set of uplink power control parameters control of the wireless device's transmissions of the first type of signals when the transmissions are comprised in the second set of time and/or frequency resources.

44. The network node of claim 43, wherein the second set of uplink power control parameters comprises one or more of: UE-specific uplink power control parameters, UE-group specific uplink power control parameters, or cell-specific uplink power control parameters.

45. The network node of claim 43, wherein the second set of time and/or frequency resources is comprised in a pattern.

46. The network node of claim 43, wherein the first and second sets of time and/or frequency resources are comprised in the same subframe.

47. The network node of claim 43, wherein the first and second sets of time and/or frequency resources are comprised in different subframes.

48. The network node of claim 43, wherein at least one of the first and second set of time and/or frequency resources is comprised in a part of the system bandwidth.

49. The network node of claim 43, wherein the uplink power control parameters are pre-defined.

50. The network node of claim 43, wherein the second set of time and/or frequency resources comprises restricted resources, which restricted resources of a cell overlap with low-interference time and/or frequency resources configured in an interfering neighbor cell; and wherein the first set of time and/or frequency resources comprises any of: restricted and non-restricted resources.

51. The network node of claim 43, wherein the first type of signal is a physical uplink control channel, a physical uplink data channel, a physical uplink reference signal, or a physical random access channel.

52. The network node of claim 43, further comprising:
a transmitting circuit configured to transmit the first and/or second sets of uplink power control parameters to the wireless device and/or to another network node.

53. The network node of claim 43, further comprising:
a receiving circuit configured to receive from the wireless device a capability associated with the ability to support two sets of uplink power control parameters for uplink transmissions of the first type of signal.

54. The network node of claim 43, further comprising:
a receiving circuit configured to receive the first type of signal by the wireless device.
